(19) United States
(12) Patent Application Publication
(10) Pub. No.: US 2017/0310048 A1
(43) Pub. Date: Oct. 26, 2017

(54) CONNECTOR

(71) Applicant: ACES ELECTRONICS CO., LTD., Zhongli City (TW)

(72) Inventors: Nobukazu Kato, Fussa-shi (JP); Hiroaki Hashimoto, Sagamihara-shi (JP)

(73) Assignee: ACES ELECTRONICS CO., LTD., Zhongli City (TW)

(21) Appl. No.: 15/488,882

(22) Filed: Apr. 17, 2017

(30) Foreign Application Priority Data
Apr. 26, 2016 (JP) 2016-087696
Oct. 7, 2016 (JP) 2016-198739

(51) Int. Cl. H01R 13/631; H01R 13/6581; H01R 24/60; H01R 107/00

(52) U.S. Cl. CPC H01R 13/6315; H01R 24/60; H01R 13/6581; H01R 2107/00

(57) ABSTRACT

{Problem} To provide a connector which includes two or more predetermined standard connectors and is capable of securely absorbing deviation in a position and a posture of the two or more predetermined standard connectors during mounting thereof.

{Solution to Problem} A connector including a plurality of predetermined standard connectors 2a, 2b which connects with a partner connector; and covers 4, 5 having a first opening portion covering the plurality of predetermined standard connectors and allowing an engagement portion to be exposed, the engagement portion to be engaged with the partner connector of the predetermined standard connector, in which between an outer wall portion 33a of the predetermined standard connector and a wall portion forming the first opening portion, a predetermined space is formed such that the predetermined standard connector can move relative to the cover on a cross plane crossing an engagement direction of engagement with the partner connector, and a first control portion which controls, with respect to the first opening portion, at least either one of a position and a posture of at least one of the predetermined standard connectors.

### CROSS-REFERENCE TO RELATED APPLICATIONS

The present application claims priority from Japanese Patent Application No. 2016-087696 filed on Apr. 26, 2016 and Japanese Patent Application No. 2016-198739 filed on Oct. 7, 2016, disclosures of which are all incorporated herein.

### TECHNICAL FIELD

The present invention relates to a connector including a plurality of predetermined standard connectors.

### RELATED ART

### Background Art

There are provided connectors having numerous contacts in order to realize high-speed transmission. For example, Patent Literature 1 recites a connector including a pair of connectors each having numerous contacts aligned, in which one connector is engaged with the other connector.

### CITATION LIST

### Patent Literature

Patent Literature 1: JP H11-288760 A

### SUMMARY OF INVENTION

### Technical Problem

In the connector recited in the Patent Literature 1, one connector can be engaged only with other connector, but not with a connector conforming to a different standard from that of the other connector.

Thus, use of a connector has been studied which includes two or more connectors conforming to the standard specification (hereinafter, referred to as a predetermined standard connector) such as the USB Type-C or the like. For example, a receptacle connector having two predetermined standard receptacle connectors can be connected not only with a plug connector having two predetermined standard plug connectors but also with an apparatus mounted with one predetermined standard plug connector or with a cable. In other words, one of the two predetermined standard receptacle connectors provided in the receptacle connector can be connected with an apparatus mounted with one predetermined standard plug connector or with the cable as well. Further, the other of the two predetermined standard receptacle connectors provided in the above receptacle connector can be connected with other apparatus mounted with a predetermined standard plug connector or with other cable as well.

However, in a step of assembling such a connector having two or more predetermined standard connectors as described above, it is difficult to mount two predetermined standard connectors at an accurate position and in an accurate posture. When positions and postures of the two predetermined standard connectors deviate from each other during mounting, connection of the predetermined standard connector with a partner connector might develop a failure, or engagement of the predetermined standard connector with the partner connector might cause breakage.

Additionally, in order to realize higher speed transmission by increasing the number of contacts, it is demanded to mount an additional connector on such a connector including two or more of such predetermined standard connectors as described above. However, also when an additional connector is mounted, it is difficult to mount two predetermined standard connectors and the additional connector at an accurate position and in an accurate posture during a step of assembling the connector.

An object of the present invention is to provide a connector which includes two or more predetermined standard connectors and is capable of securely absorbing deviation in a position and a posture of the two or more predetermined standard connectors during mounting thereof.

### Solution to Problem

A connector of the present invention includes a plurality of predetermined standard connectors which connects with a partner connector; and a cover covering the plurality of predetermined standard connectors and having a first opening portion allowing an engagement portion to be exposed, the engagement portion to be engaged with the partner connector of the predetermined standard connector, in which between an outer wall portion of the predetermined standard connector and a wall portion forming the first opening portion, a predetermined space is formed such that the predetermined standard connector is movable relative to the cover on a cross plane crossing an engagement direction of engagement with the partner connector, and a first control portion is provided which controls, with respect to the first opening portion, at least either one of a position and a posture of at least one of the predetermined standard connectors.

Additionally, the connector of the present invention includes an additional connector to be connected with a partner's additional connector, in which the cover covers the additional connector and has a second opening portion allowing an engagement portion of the additional connector to be exposed, the engagement portion to be engaged with the partner's additional connector, between an outer wall portion of the additional connector and a wall portion forming the second opening portion, a predetermined space is formed such that the additional connector is movable on the cross plane, and a second control portion is provided which controls, with respect to the second opening portion, at least either one of a position and a posture of the additional connector.

Additionally, in the connector of the present invention, the first control portion and the second control portion each include an elastic body.

Additionally, in the connector of the present invention, the first control portion is provided in the outer wall portion of the predetermined standard connector or in the wall portion forming the first opening portion.

Additionally, in the connector of the present invention, the second control portion is provided in the outer wall portion of the additional connector or in the wall portion forming the second opening portion.

Additionally, in the connector of the present invention, the first control portion is provided between the predetermined standard connector and the cover.

Additionally, in the connector of the present invention, the first control portion includes a convex portion which supports the predetermined standard connector in a direction orthogonal to a surface in which the first opening portion is formed; and a correction portion which corrects a slant of the predetermined standard connector when the predetermined standard connector slants with respect to the surface in which the first opening portion is formed, and the first control portion controls a posture of the predetermined standard connector with respect to the first opening portion by using the convex portion and the correction portion.

Additionally, in the connector of the present invention, the cover and a shell of the predetermined standard connector electrically conduct with each other.

Additionally, the connector of the present invention further includes a flexible portion which follow movement of the predetermined standard connector; a first holding portion fixed to the predetermined standard connector for holding one of the flexible portion; and a second holding portion fixed to the cover for holding the other of the flexible portion.

Additionally, in the connector of the present invention, the predetermined standard connector includes a first contact having a first connection portion which is pushed to a first conductor to electrically connect with the first conductor; a first supporting portion which receives a force to push the first connection portion to the first conductor; a second contact having a second connection portion which is pushed to a second conductor to electrically connect with the second conductor; a second supporting portion which receives a force to push the second connection portion to the second conductor; a ground plate arranged between the first contact and the second contact and having a shield connection portion which is pushed to at least one of a first shield portion covering the first conductor and a second shield portion covering the second conductor to electrically connect with at least one of the first shield portion and the second shield portion; and a third supporting portion which receives a force to push the shield connection portion to at least one of the first shield portion and the second shield portion.

Additionally, the connector of the present invention includes a first contact having a first connection portion which is pushed to a first conductor to electrically connect with the first conductor; a first supporting portion which receives a force to push the first connection portion to the first conductor; a second contact having a second connection portion which is pushed to a second conductor to electrically connect with the second conductor; a second supporting portion which receives a force to push the second connection portion to the second conductor; a ground plate arranged between the first contact and the second contact and having a shield connection portion which is pushed to at least one of a first shield portion covering the first conductor and a second shield portion covering the second conductor to electrically connect with at least one of the first shield portion and the second shield portion; and a third supporting portion which receives a force to push the shield connection portion to at least one of the first shield portion and the second shield portion.

Additionally, in the connector of the present invention, at least one of the first connection portion and the second connection portion is integrally formed with the third supporting portion.

Additionally, in the connector of the present invention, the first conductor and the second conductor are each a conductor configuring a flexible flat cable or a conductor foil configuring a flexible printed board.

Additionally, in the connector of the present invention, the predetermined standard connector is of the USB Type C.

### Advantageous Effects of Invention

According to the present invention, a connector can be provided which includes two or more predetermined standard connectors and is capable of securely absorbing deviation in a position and a posture of the two or more predetermined standard connectors during mounting thereof.

### BRIEF DESCRIPTION OF DRAWINGS

FIG. 1 is a perspective view showing an appearance of a connector according to a first embodiment;

FIG. 2 is a view of the connector according to the first embodiment seen from above;

FIG. 3 is a view showing a state where a casing is taken out from the connector according to the first embodiment;

FIG. 4 is a view showing a state where a plug connector and an additional plug connector are taken out from a mount plate;

FIG. 5 is an exploded view showing a configuration of the plug connector according to the first embodiment;

FIG. 6 is an end view showing the configuration of the plug connector according to the first embodiment;

FIG. 7 is an extended view showing configurations of a contact portion between a first contact and a first conductor and a contact portion between a second contact and a second conductor of the plug connector according to the first embodiment;

FIG. 8 is an end view showing the configuration of the plug connector according to the first embodiment;

FIG. 9 is an extended view showing a configuration of a contact portion between a ground plate and a first shield portion of the plug connector according to the first embodiment;

FIG. 10 is an exploded view showing a configuration of the additional plug connector according to the first embodiment;

FIG. 11 is an extended view showing another configuration of the contact portion between the ground plate and the first shield portion;

FIG. 12 is a perspective view showing an appearance of a plug docking connector according to a second embodiment;

FIG. 13 is a bottom plan view showing the appearance of the plug docking connector according to the second embodiment;

FIG. 14 is an exploded view showing a configuration of the plug docking connector according to the second embodiment;

FIG. 15 is a perspective view showing an appearance of a front cover according to the second embodiment;

FIG. 16 is a view showing a configuration of a control portion according to the second embodiment;

FIG. 17 is a sectional view showing a configuration of the plug docking connector according to the second embodiment;

FIG. 18 is a perspective view showing an appearance of a receptacle docking connector according to the second embodiment;

FIG. 19 is a front view showing the appearance of the receptacle docking connector according to the second embodiment;

FIG. 20 is a plan view showing the appearance of the receptacle docking connector according to the second embodiment;

FIG. 21 is a bottom plan view showing the appearance of the receptacle docking connector according to the second embodiment;

FIG. 22 is an exploded view showing a configuration of the receptacle docking connector according to the second embodiment;

FIG. 23 is an exploded view showing the configuration of the receptacle docking connector according to the second embodiment;

FIG. 24 is a sectional view showing the configuration of the receptacle docking connector according to the second embodiment;

FIG. 25 is a sectional view showing the configuration of the receptacle docking connector according to the second embodiment;

FIG. 26 is a perspective view showing an appearance of other plug docking connector;

FIG. 27 is a bottom plan view showing the appearance of other plug docking connector;

FIG. 28 is an exploded view showing a configuration of other plug docking connector;

FIG. 29 is a sectional view showing the configuration of other plug docking connector;

FIG. 30 is a perspective view showing an appearance of other receptacle docking connector;

FIG. 31 is a front view showing the appearance of other receptacle docking connector;

FIG. 32 is an exploded view showing a configuration of other receptacle docking connector;

FIG. 33 is a sectional view showing the configuration of other receptacle docking connector;

FIG. 34 is a perspective view showing a state where a docking station mounted with a plug unit and a personal computer mounted with a receptacle unit are docked with each other according to a third embodiment;

FIG. 35 is a perspective view showing an appearance of the docking station mounted with the plug unit according to the third embodiment;

FIG. 36 is an exploded view showing a configuration of the docking station according to the third embodiment;

FIG. 37 is a perspective view showing an appearance of the plug unit according to the third embodiment;

FIG. 38 is an exploded view showing a configuration of the plug unit according to the third embodiment;

FIG. 39 is a front view showing a configuration of a plug docking connector according to the third embodiment;

FIG. 40 is an exploded view showing the configuration of the plug docking connector according to the third embodiment;

FIG. 41 is a sectional view showing the configuration of the plug docking connector according to the third embodiment;

FIG. 42 is a sectional view showing the configuration of the plug docking connector according to the third embodiment;

FIG. 43 is an exploded view showing a configuration of a floating portion according to the third embodiment;

FIG. 44 is an exploded view showing configurations of a plug connector, a circuit board, an upper coaxial cable, a lower coaxial cable, and a swing adaptor according to the third embodiment;

FIG. 45 is a perspective view showing a configuration of a control portion according to the third embodiment;

FIG. 46 is an exploded view showing a configuration of the personal computer mounted with the receptacle unit according to the third embodiment; and

FIG. 47 is a perspective view showing a configuration of a cable dock including a plug unit according to other embodiment.

### DESCRIPTION OF EMBODIMENTS

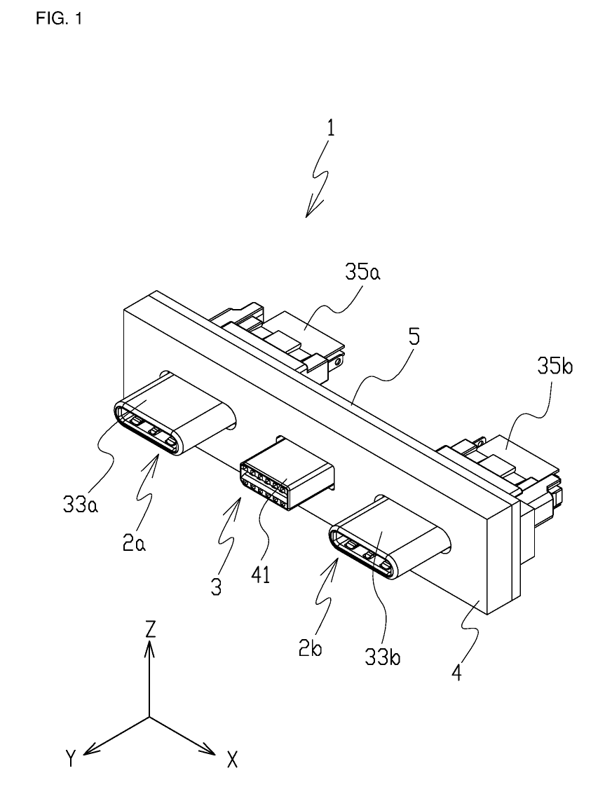

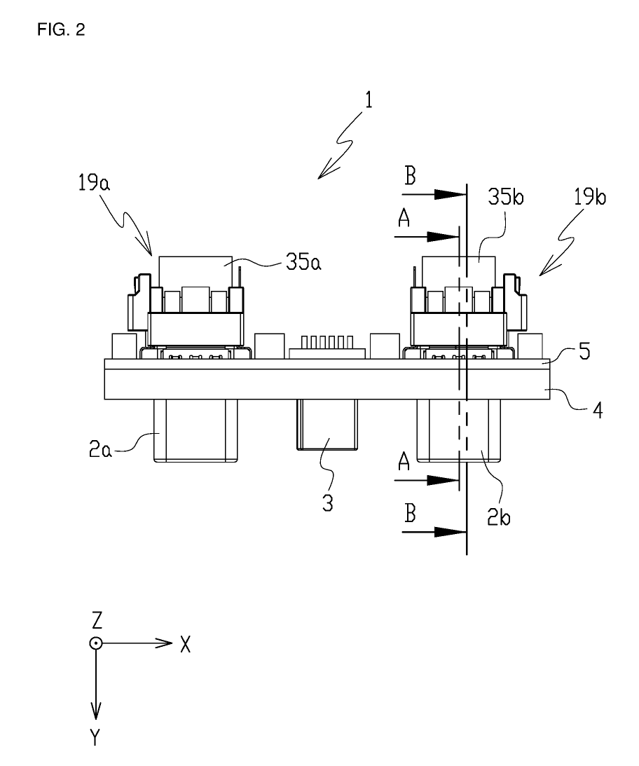

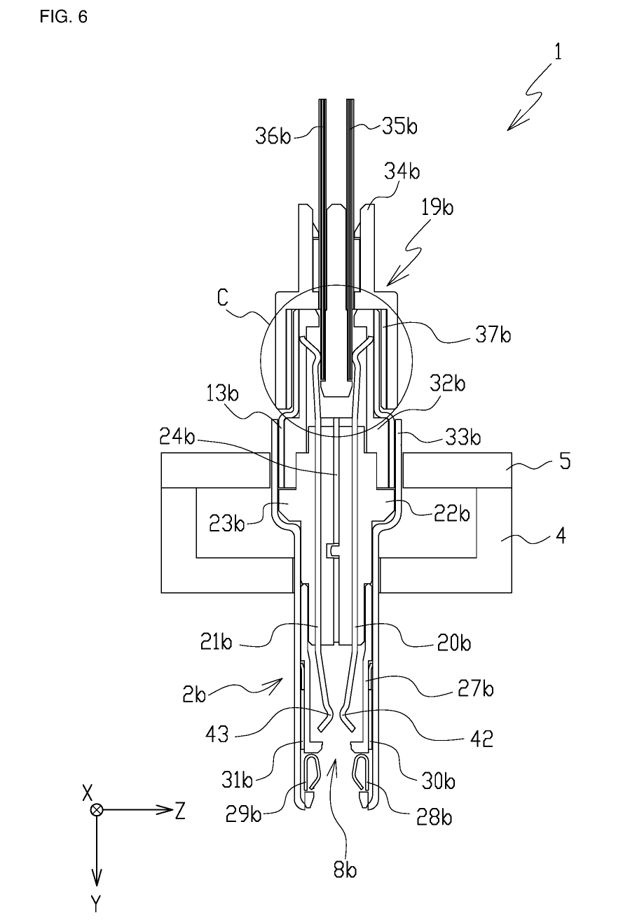

In the following, with reference to the drawings, a connector (plug connector) according to a first embodiment of the present invention will be described. FIG. 1 is a perspective view showing an appearance of a connector according to the first embodiment, and FIG. 2 is a view of the connector seen from above. As shown in FIG. 1 and FIG. 2, a connector 1 includes two USB Type-C plug connectors (hereinafter, referred to simply as plug connectors) 2a and 2b, an additional plug connector 3, a casing 4, and a mount plate 5. FIG. 1 and FIG. 2 show a state where to the plug connectors 2a and 2b, a first flexible flat cable (hereinafter, referred to as a first FFC) 35a, a second flexible flat cable (hereinafter, referred to as a second FFC) not shown, a first FFC 35b and a second FFC 36b (see FIG. 6) are connected.

Additionally, in the following, with an XYZ orthogonal coordinate system set as shown in FIG. 1, description will be made of a positional relationship and the like of each member with reference to the orthogonal coordinate system. An X axis is set to be parallel to a direction in which the plug connector 2a, the additional plug connector 3, and the plug connector 2b are arranged. A Y axis is set to be parallel to a direction in which the connector 1 is engaged with a partner connector (a receptacle connector not shown). A Z axis is set to be orthogonal to an XY plane. Additionally, a side of the plug connector 2b is set to be a +X direction, a side of the plug connector 2a is set to be a −X direction, a direction in which the connector 1 is engaged with the partner connector is set to be a +Y direction, and a direction in which the connector 1 is pulled out from the partner connector is set to be a −Y direction.

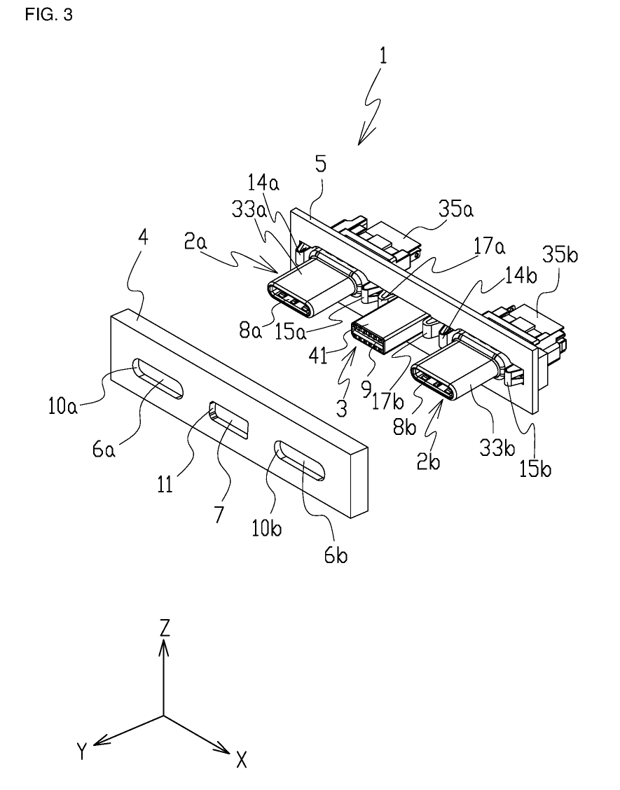

FIG. 3 is a view showing a state where the casing 4 is taken out from the connector 1. As shown in FIG. 3, on the −X direction side of the casing 4, there is formed a first opening portion 6a covering the plug connector 2a and for exposing an engagement portion 8a by which the plug connector 2a engages with a USB Type-C receptacle connector (hereinafter, simply referred to as a receptacle connector) not shown. Additionally, on the +X direction side of the casing 4, there is formed a first opening portion 6b covering the plug connector 2b and for exposing an engagement portion 8b by which the plug connector 2b engages with a receptacle connector (not shown). Further, between the first opening portion 6a and the first opening portion 6b, there is formed a second opening portion 7 covering the additional plug connector 3 and for exposing an engagement portion 9 by which the additional plug connector 3 engages with a partner's additional receptacle connector (not shown).

Between an outer wall portion of the plug connector 2a, i.e. a plug shell 33a which will be described later and a wall portion 10a forming the first opening portion 6a, a predetermined space is formed such that on a surface in which the first opening portion 6a is formed (a ZX plane), the plug connector 2a can move as shown in FIG. 1. Similarly, between an outer wall portion of the plug connector 2b, i.e. a plug shell 33b which will be described later and a wall portion 10b forming the first opening portion 6b, a predetermined space is formed such that on a surface in which the first opening portion 6b is formed (the ZX plane), the plug connector 2b can move. Additionally, between an outer wall portion of the additional plug connector 3, i.e. an addition side shell 41 which will be described later and a wall portion 11 forming the second opening portion 7, a predetermined space is formed such that on a surface in which the second opening portion 7 is formed (the ZX plane), the additional plug connector 3 can move.

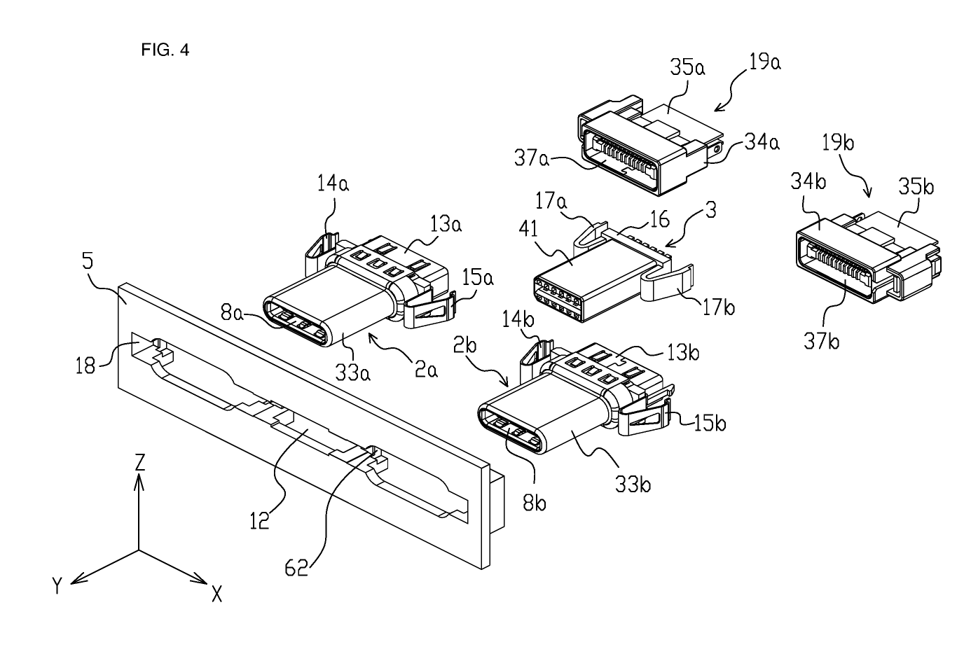

FIG. 4 is a view showing a state where the plug connectors 2a and 2b and the additional plug connector 3 are taken out from the mount plate 5, and a state where adaptors 19a and 19b to be described later are taken out from the plug connectors 2a and 2b. The mount plate 5 is formed of a member having conductive properties and functions as a cover which covers the plug connectors 2a and 2b and the additional plug connector 3. As shown in FIG. 4, in the mount plate 5, there is formed an opening portion 12 covering the plug connectors 2a and 2b and the additional plug connector 3 and for exposing the engagement portions 8a and 8b of the plug connectors 2a and 2b, and the engagement portion 9 of the additional plug connector 3.

The plug connector 2a includes a first control portion 13a at the rear of the plug shell 33a (a −Y direction side). The first control portion 13a is formed of a member having conductive properties, for example, of metal and includes two elastic members 14a and 15a. The elastic member 14a is formed on the −X direction side of the first control portion 13a, and the elastic member 15a is formed on the +X direction side of the first control portion 13a. As shown in FIG. 3, the elastic members 14a and 15a are arranged in the opening portion 12 and in contact with the mount plate 5 and the plug shell 33a. Specifically, the mount plate 5 is electrically connected to the plug shell 33a via the elastic members 14a and 15a, so that the mount plate 5 and the plug shell 33a electrically conduct with each other. The elastic member 14a pushes the −X direction side of a wall portion 18 forming the opening portion 12 in the −X direction by an elastic force. The −X direction side of the wall portion 18 forming the opening portion 12 receives the elastic force of the elastic member 14a. Additionally, the elastic member 15a pushes a rear of the opening portion 12, i.e. a wall portion (not shown) formed on the −Y direction side of the mount plate 5 in the +X direction by an elastic force. The wall portion (not shown) formed on the −Y direction side of the mount plate 5 receives the elastic force of the elastic member 15a.

The first control portion 13a controls a position and a posture of the plug connector 2a in the X direction with respect to the first opening portion 6a, i.e. a slant with respect to an X axis direction by using elastic forces of the elastic members 14a and 15a. When a force in the −X direction is applied to the plug connector 2a, the elastic member 14a contracts in the −X direction and the elastic member 15a extends in the −X direction. Accordingly, the plug connector 2a moves in the −X direction within a predetermined space formed between the plug shell 33a and the wall portion 10a. When a force in the +X direction is applied to the plug connector 2a, the elastic member 14a extends in the +X direction and the elastic member 15a contracts in the +X direction. Accordingly, the plug connector 2a moves in the +X direction within the predetermined space formed between the plug shell 33a and the wall portion 10a.

Additionally, applying, to the plug connector 2a, a force in a direction slanting with respect to the X axis direction changes the elastic forces of the elastic members 14a and 15a, so that a posture of the plug connector 2a changes to a direction in which the force is applied within the predetermined space formed between the plug shell 33a and the wall portion 10a. When the force applied to the plug connector 2a is released, by the elastic forces of the elastic members 14a and 15a, the plug connector 2a returns to a position and a posture of the plug connector 2a as of before the force is applied thereto.

Additionally, to the plug connector 2a, the adaptor 19a is coupled as shown in FIG. 2. The adaptor 19a is configured to include a housing 34a, a first FFC 35a, a second FFC not shown, and a shell 37a as shown in FIG. 4. The first FFC 35a is arranged on the +Z direction side of the adaptor 19a, and the second FFC not shown is arranged on the −Z direction side of the adaptor 19a. The adaptor 19a is a member for assisting connection between the first FFC 35a and a first contact not shown of the plug connector 2a, and connection between the second FFC not shown and a second contact not shown of the plug connector 2a. The housing 34a holds the first FFC 35a, the second FFC not shown, and the shell 37a. The shell 37a and the housing 34a regulate positions and postures, in the Z direction, of +Y direction side parts of the first FFC 35a and the second FFC not shown. Accordingly, a reaction force in the Z direction generated when the adaptor 19a engages with the plug connector 2a is suppressed.

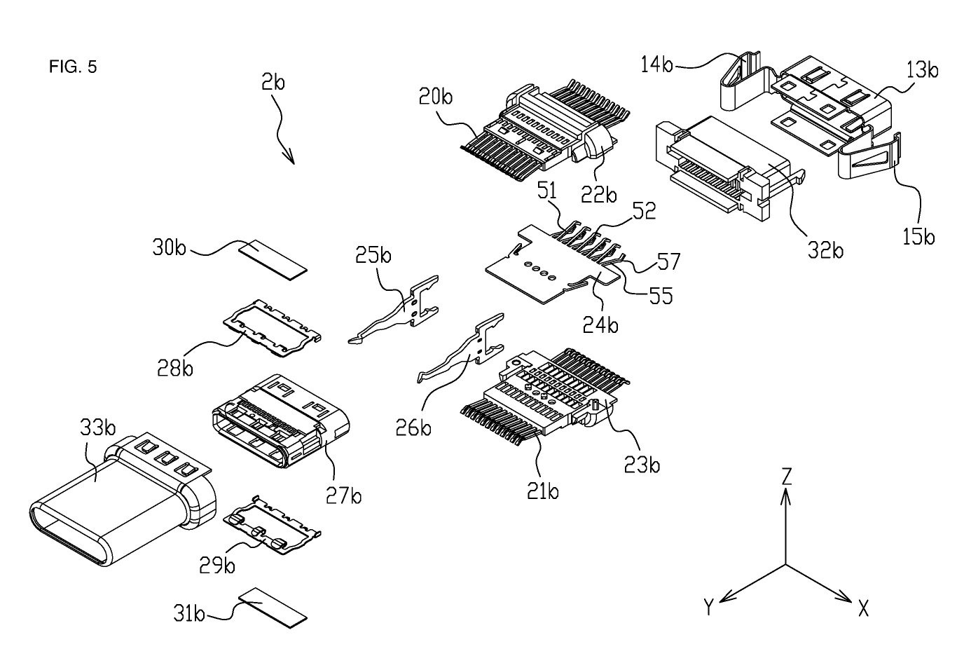

Next, a configuration of the plug connector 2b will be described. The plug connector 2b includes a first control portion 13b (see FIG. 5) at the rear of the plug shell 33b (the −Y direction side). The first control portion 13b is formed of a member having conductive properties, for example, of metal and includes two elastic members 14b and 15b. The elastic member 14b is formed on the −X direction side of the first control portion 13b, and the elastic member 15b is formed on the +X direction side of the first control portion 13b. As shown in FIG. 3, the elastic members 14b and 15b are arranged in the opening portion 12 and in contact with the mount plate 5 and the plug shell 33b. Specifically, the mount plate 5 is electrically connected with the plug shell 33b via the elastic members 14b and 15b, so that the mount plate 5 and the plug shell 33b electrically conduct with each other. The elastic member 14b pushes a wall portion 62 formed on the −Y direction side of the mount plate 5 in the −X direction by an elastic force. The wall portion 62 formed on the −Y direction side of the mount plate 5 receives the elastic force of the elastic member 14b. Additionally, the elastic member 15b pushes the +X direction side of the wall portion 18 forming the opening portion 12 in the +X direction by an elastic force. The +X direction side of the wall portion 18 forming the opening portion 12 receives the elastic force of the elastic member 14b. The first control portion 13b controls a position and a posture of the plug connector 2b in the X direction with respect to the first opening portion 6b, i.e. a slant with respect to the X axis direction by using the elastic forces of the elastic members 14b and 15b. Since position control and posture control of the plug connector 2b in the first control portion 13b are the same as position control and posture control of the plug connector 2a in the first control portion 13a, no description will be made thereof.

Additionally, to the plug connector 2b, the adaptor 19b is coupled as shown in FIG. 2. The adaptor 19b is configured to include a housing 34b, the first FFC 35b, the second FFC 36b (see FIG. 6), and a shell 37b as shown in FIG. 4. The first FFC 35b is arranged on the +Z direction side of the adaptor 19b, and the second FFC 36b is arranged on the −Z direction side of the adaptor 19b. The adaptor 19b is a member for assisting connection between the first FFC 35b and a first contact 20b of the plug connector 2b (see FIG. 5), and connection between the second FFC 36b and a second contact 21b of the plug connector 2b (see FIG. 5). The housing 34b holds the first FFC 35b, the second FFC 36b, and the shell 37b. The shell 37a and the housing 34a regulate positions and postures, in the Z direction, of +Y direction side parts of the first FFC 35a and the second FFC not shown. Accordingly, a reaction force in the Z direction generated when the adaptor 19b engages with the plug connector 2b is suppressed.

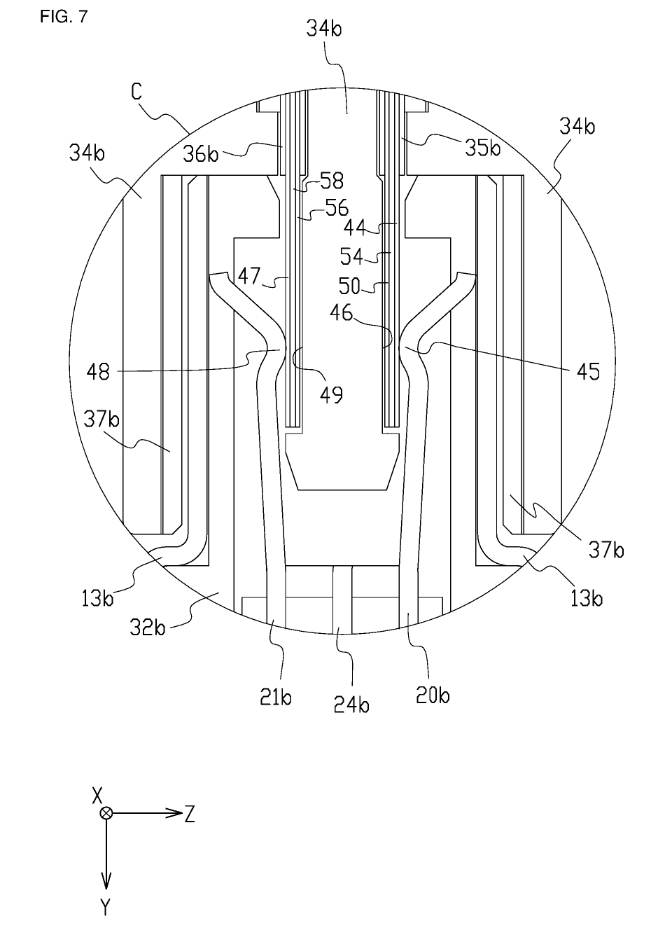

FIG. 5 is an exploded view showing a configuration of the plug connector 2b, FIG. 6 is an end view taken along A-A of FIG. 2, and FIG. 7 is an extended view of the members surrounded by a circle C shown in FIG. 6. As shown in FIG. 5 and FIG. 6, the plug connector 2b includes a plurality (12 in this first embodiment) of first contacts 20b and a plurality (12 in this first embodiment) of second contacts 21b, which contacts connect with a plurality of contacts of the receptacle connector not shown. The plurality of first contacts 20b is arranged on the +Z direction side of the plug connector 2b, and the plurality of second contacts 21b is arranged on the −Z direction side of the plug connector 2b. Additionally, as shown in FIG. 6, each of the first contacts 20b includes a contact portion 42 at an end portion thereof on the +Y direction side, the contact portion for coming into contact with a contact of the receptacle connector not shown. Additionally, each of the second contacts 21b includes a contact portion 43 at an end portion thereof on the +Y direction side, the contact portion for coming into contact with a contact of the receptacle connector not shown.

Additionally, as shown in FIG. 7, at an end portion of the first contact 20b on the −Y direction side, a first connection portion 45 is formed for the connection with a first conductor 44 of the first FFC 35b. The end portion of the first contact 20b on the −Y direction side is formed of an elastic body including the first connection portion 45. Accordingly, the first contact 20b electrically connects with the first conductor 44 by pushing of the first connection portion 45 to the first conductor 44 (the −Z direction) by an elastic force of the elastic body. Additionally, a first supporting surface 46 of the housing 34b provided in the adaptor 19b receives a force of pressing the first connection portion 45 to the first conductor 44 (the elastic force of the elastic body). The first FFC 35b includes a plurality of the first conductors 44 connecting to the plurality of first contacts 20b, respectively.

At an end portion of the second contact 21b on the −Y direction side, a second connection portion 48 is formed for the connection with a second conductor 47 of the second FFC 36b. The end portion of the second contact 21b on the −Y direction side is formed of an elastic body including the second connection portion 48. Accordingly, the second contact 21b electrically connects with the second conductor 47 by pushing of the second connection portion 48 to the second conductor 47 (the +Z direction) by an elastic force of the elastic body. Additionally, a second supporting surface 49 of the housing 34b provided in the adaptor 19b receives a force of pressing the second connection portion 48 to the second conductor 47 (the elastic force of the elastic body). The second FFC 36b includes a plurality of the second conductors connecting to the plurality of second contacts 21b, respectively.

Additionally, the plug connector 2b includes an insert housing 22b and an insert housing 23b each formed of an insulator as shown in FIG. 5 and FIG. 6. The insert housing 22b holds the plurality of first contacts 20b, and the insert housing 23b holds the plurality of second contacts 21b.

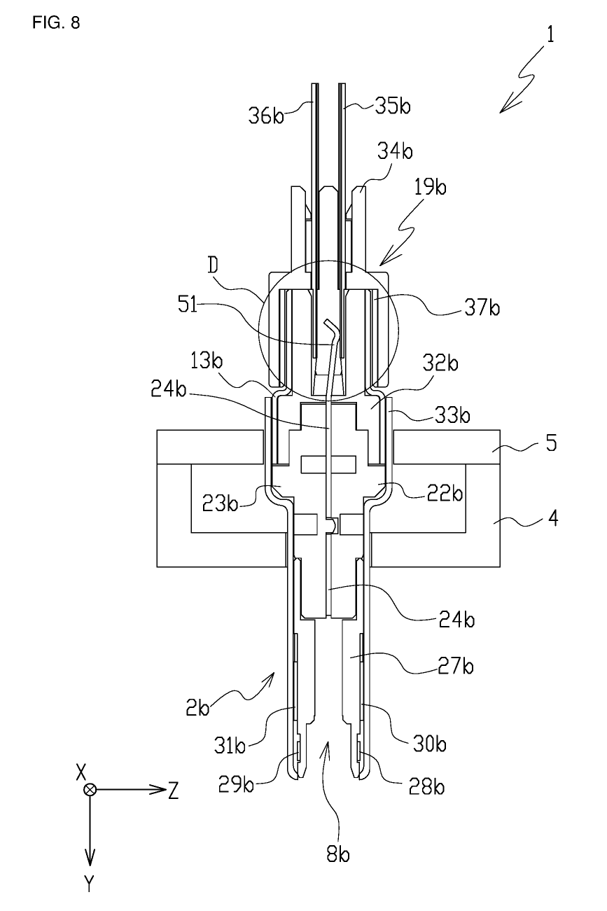

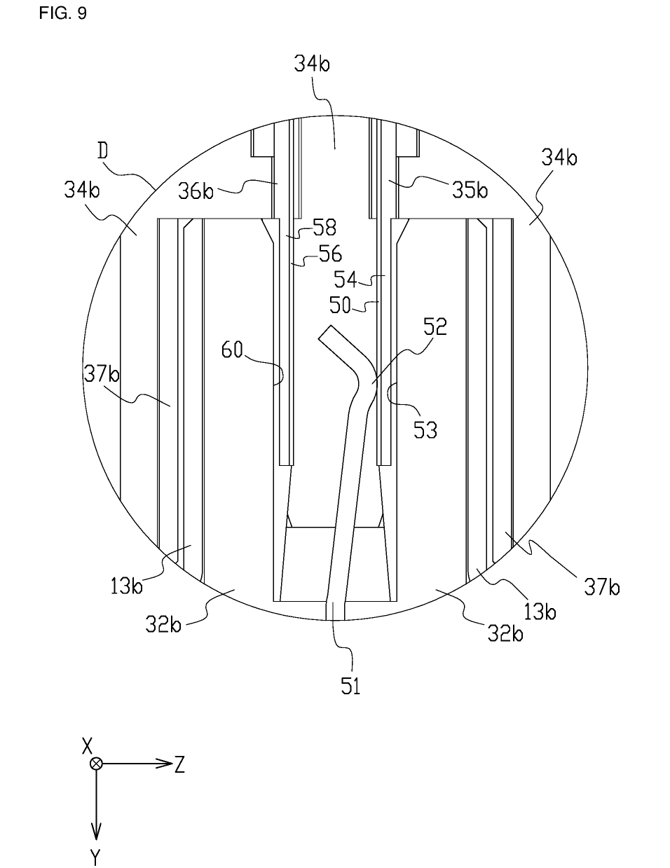

Additionally, the plug connector 2b includes a ground plate 24b between the first contact 20b and the second contact 21b. At an end portion of the ground plate 24b on the −Y direction side, a plurality (five in the first embodiment) of first elastic members 51 is provided for the connection with a first shield portion 50 of the first FFC 35b. FIG. 8 is an end view taken along B-B in FIG. 2, and FIG. 9 is an extended view of the members surrounded by a circle D shown in FIG. 8. As shown in FIG. 9, at an end portion of the first elastic member 51 on the −Y direction side, a first shield connection portion 52 is formed for the connection with the first shield portion 50 of the first FFC 35b. The first shield connection portion 52 and the first shield portion 50 electrically connect with each other by pushing of the first shield connection portion 52 to the first shield portion 50 (the +Z direction) by an elastic force of the first elastic member 51. As a result, the ground plate 24b electrically connects with the first shield portion 50 of the first FFC 35b via the first elastic member 51. Additionally, a third supporting surface 53 of a housing 32b (to be described later) provided in the plug connector 2b receives the force which pushes the first shield connection portion 52 to the first shield portion 50 (the elastic force of the first elastic member 51). The first FFC 35b includes one first shield portion 50 to be connected with the plurality of first elastic members 51. Additionally, between the plurality of first conductors 44 of the first FFC 35b and one first shield portion 50, an insulator 54 is interposed.

Additionally, as shown in FIG. 5, at the end portion of the ground plate 24b on the −Y direction side, a plurality (five in this first embodiment) of second elastic members 55 is provided for the connection with a second shield portion 56 of the second FFC 36b (see FIG. 7). At an end portion of the second elastic members 55 on the −Y direction side, a second shield connection portion 57 is formed for the connection with the second shield portion 56 of the second FFC 36b. The second shield connection portion 57 and the second shield portion 56 electrically connect with each other by pushing of the second shield connection portion 57 to the second shield portion 56 (the −Z direction) by an elastic force of the second elastic members 55. In other words, the ground plate 24b electrically connects with the second shield portion 56 of the second FFC 36b via the second elastic members 55. Additionally, a third supporting surface 60 (see FIG. 9) of the housing 32b provided in the plug connector 2b receives the force which pushes the second shield connection portion 57 to the second shield portion 56 (the elastic force of the second elastic members 55). The second FFC 36b includes one second shield portion 56 to be connected with the plurality of second elastic members 55. Additionally, an insulator 58 is interposed between the plurality of second conductors 47 and one second shield portion 56 of the second FFC 36b.

Additionally, as shown in FIG. 5, the plug connector 2b includes two ground contacts 25b and 26b. The ground contact 25b is arranged on the −X direction side of the plug connector 2b, and the ground contact 26b is arranged on the +X direction side of the plug connector 2b, the ground contacts 25b and 26b being connected to the ground plate 24b.

Additionally, the plug connector 2b includes a plug housing 27b. In the plug housing 27b, there are provided a part on the +Y direction side of the plurality of first contacts 20b, the part being held by the insert housing 22b, a part on the +Y direction side of the plurality of the first contacts 20b, the part being held by the insert housing 23b, the ground plate 24b, and parts on the +Y direction side of the two ground contacts 25b and 26b. The insert housings 22b and 23b and the plug housing 27b regulate positions and postures, in the Z direction, of the part on the +Y direction side of the plurality of first contacts 20b, the part on the +Y direction side of the plurality of first contacts 20b, and the part on the +Y direction side of the ground plate 24b. Additionally, the plug housing 27b holds ground plate contacts 28b and 29b, and in the vicinity of the ground plate contacts 28b and 29b, insulation plates 30b and 31b are arranged, respectively.

The ground plate contact 28b and the insulation plate 30b are arranged on the +Z direction side of the plug housing 27b. When the plug connector 2b engages with a receptacle connector not shown, the ground plate contact 28b connects with a ground shell of the receptacle connector. The ground plate contact 29b and the insulation plate 31b are arranged on the −Z direction side of the plug housing 27b. The ground plate contact 29b connects with the ground shell of the receptacle connector when the plug connector 2b engages with the receptacle connector.

Additionally, the plug connector 2b includes the housing 32b. In the housing 32b, there are arranged a part on the −Y direction side of the plurality of first contacts 20b, the part being held in the insert housing 22b, a part on the −Y direction side of the plurality of second contacts 21b, the part being held in the insert housing 23b, the ground plate 24b, and parts on the −Y direction side of the two ground contacts 25b and 26b. The housing 32b has an outer circumference thereof covered with the first control portion 13b. The housing 32b and the first control portion 13b regulate positions and postures, in the Z direction, of the part on the −Y direction side of the plurality of first contacts 20b, the part on the −Y direction side of the plurality of first contacts 20b, and the part on the −Y direction side of the ground plate 24b. Accordingly, a reaction force generated in the Z direction when the plug connector 2b couples with the adaptor 19b is suppressed.

Additionally, the plug connector 2b has the plug shell 33b, which plug shell 33b covers an outer circumference of the plug housing 27b and an outer circumference on the +Y direction side of the first control portion 13b. Similarly to the insert housings 22b and 23b, and the plug housing 27b, a plug shell 33 regulates positions and postures, in the −Z direction, of the part on the +Y direction side of the plurality of first contacts 20b, the part on the +Y direction side of the plurality of first contacts 20b, and the part on the +Y direction side of the ground plate 24b. Accordingly, reaction force generated in the Z direction when the plug connector 2b engages with the receptacle connector is suppressed.

The plug connector 2a includes a plurality of first contacts not shown, a plurality of second contacts not shown, two insert housings not shown, a ground plate not shown, two ground contacts not shown, a plug housing not shown, two ground plate contacts not shown, two insulation plates not shown, a housing not shown, and the plug shell 33a (see FIG. 4). With a Y axis direction of the connector 1 as a center line, configurations of these portions are line-symmetrically the same as the plurality of first contacts 20b, the plurality of second contacts 21b, the insert housings 22b and 23b, the ground plate 24b, the ground contacts 25b and 26b, the plug housing 27b, the ground plate contacts 28b and 29b, the insulation plates 30b and 31b, the housing 32b, and the plug shell 33b.

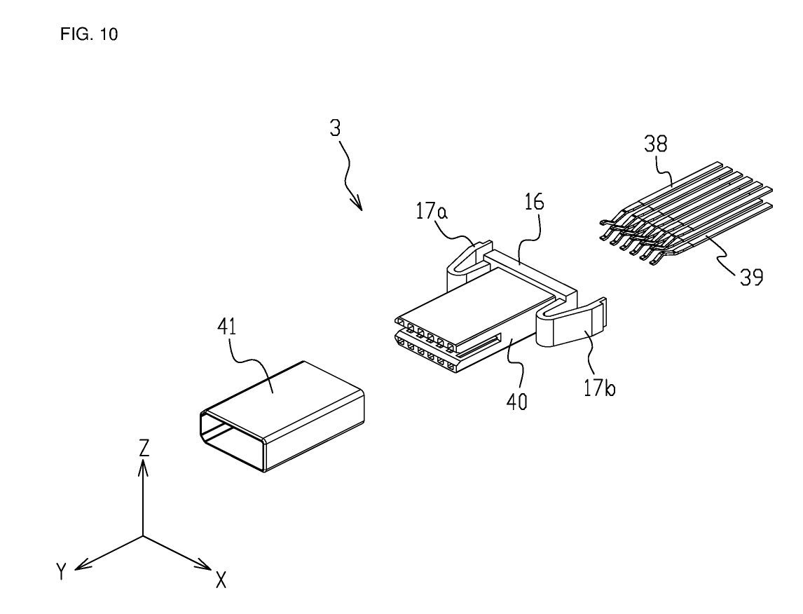

Next, a configuration of the additional plug connector 3 will be described. FIG. 10 is an exploded view showing the configuration of the additional plug connector 3. The additional plug connector 3 includes a second control portion 16 at the rear (the −Y direction side) of the addition side shell 41. The second control portion 16 is formed of an insulator, e.g. a resin, and includes two elastic members 17a and 17b. The elastic member 17a is formed on the −X direction side of the second control portion 16, and the elastic member 17b is formed on the +X direction side of the second control portion 16. As shown in FIG. 3, the elastic members 17a and 17b are arranged in the opening portion 12, with the elastic member 17a pushing, in the −X direction, a wall portion (not shown) formed at the rear of the opening portion 12, i.e. on the −Y direction side of the mount plate 5, by an elastic force. The wall portion (not shown) formed on the −Y direction side of the mount plate 5 receives the elastic force of the elastic member 17a. Additionally, the elastic member 17b pushes, in the +X direction, a wall portion (not shown) formed at the rear of the opening portion 12, i.e. on the −Y direction side of the mount plate 5, by an elastic force. The wall portion (not shown) formed on the −Y direction side of the mount plate 5 receives the elastic force of the elastic member 17b. The second control portion 16 controls a position and a posture of the additional plug connector 3 in the X direction with respect to the second opening portion 7 by using the elastic forces of the elastic members 17a and 17b. Since the position control and posture control of the additional plug connector 3 by the second control portion 16 are the same as the position control and posture control of the plug connector 2a by the first control portion 13a, no description will be made thereof.

Additionally, the additional plug connector 3 includes a plurality of contacts 38 and 39 to be connected with a plurality of contacts of an additional receptacle connector not shown. The plurality (six in this first embodiment) of contacts 38 is arranged on the +Z direction side of the additional plug connector 3, and the plurality (six in this first embodiment) of contacts 39 is arranged on the −Z direction side of the additional plug connector 3. Additionally, the additional plug connector 3 includes an addition side housing 40 formed integrally with the second control portion 16. The addition side housing 40 holds the plurality of contacts 38 and 39. Additionally, the additional plug connector 3 has the addition side shell 41, which addition side shell 41 covers an outer circumference of the addition side housing 40.

Since the connector 1 according to the first embodiment includes the first control portions 13a and 13b and the second control portion 16, and the plug connector is connected with the first FFC and the second FFC, position control and posture control of the plug connectors 2a and 2b and the additional plug connector 3 can be conducted. Specifically, since the plug connectors 2a and 2b and the additional plug connector 3 are configured to be movable within a predetermined space, the plug connectors 2a and 2b and the additional plug connector 3 can be securely engaged with the receptacle connector not shown and the partner's additional receptacle connector without damages. Additionally, without engagement with the receptacle connector, the plug connectors 2a and 2b can be maintained at a predetermined position and in a predetermined posture by position control and posture control by the first control portions 13a and 13b. Similarly, without engagement with the partner's additional receptacle connector, the additional plug connector 3 can be maintained at a predetermined position and in a predetermined posture by position control and posture control by the second control portion 16. Specifically, deviation in a position and a posture of the plug connectors 2a and 2b and the additional plug connector 3 during mounting thereof can be securely absorbed.

Additionally, even in a case where the connector 1 is mounted on an electronic apparatus, when a position of the connector with respect to a printed board mounted on the electronic apparatus is different, the connector can be easily connected with the printed board without changing a configuration or a length of the first contact, the second contact, and the ground plate. Specifically, since the first contact, the second contact, and the ground plate are connected with the first FFC and the second FFC, by connecting the first FFC and the second FFC with the printed board of the electronic apparatus, the connector 1 and printed board can be electrically connected with each other via the first FFC and the second FFC.

The above-described connector 1 according to the first embodiment, which includes the first control portions 13a and 13b and the second control portion 16 that control a position in the X direction of the plug connectors 2a and 2b and the additional plug connector 3 and a slant of the same with respect to the X axis direction, may include a floating that controls a position in the Z direction of the plug connectors 2a and 2b and the additional plug connector 3 and a slant of the same with respect to the Z axis direction. For example, with a floating having an elastic member on the ±Z direction side arranged in the opening portion 12, position control and posture control of the plug connectors 2a and 2b and the additional plug connector 3 are conducted using an elastic force of the elastic member in the ±Z direction. When a force in the ±Z direction is applied to the plug connector 2a, the plug connector 2a moves in the ±Z direction within a predetermined space formed between the plug shell 33a and the wall portion 10a due to the elastic force of the elastic member. Additionally, when the force applied to the plug connector 2a is released, the plug connector 2a returns to a previous position and posture as of before application of the force due to the elastic force of the elastic member. Control of the positions of the plug connector 2b and the additional plug connector 3 in the Z direction and a slant with respect to the Z axis direction can be also conducted similarly to control of a position of the plug connector 2a in the Z direction and a slant with respect to the Z axis direction.

Additionally, in the above connector 1 according to the first embodiment, although the first control portions 13a and 13b integrally control a position of the plug connectors 2a and 2b in the X direction and a slant with respect to the X axis direction, control may be conducted individually. For example, with one first control portion including the elastic members 14a and 14b and the other first control portion including the elastic members 15a and 15b provided, positions of the plug connectors 2a and 2b in the X direction and slants of the same in the X axis direction may be controlled by these two first control portions. Similarly, the second control portion 16, which integrally controls a position of the additional plug connector 3 in the X direction and a slant of the same in the X axis direction, may separately control the same. For example, with one second control portion including the elastic member 17a and the other second control portion including the elastic member 17b provided, a position of the additional plug connector 3 in the X direction and a slant of the same in the X axis direction may be controlled by these two second control portions.

Additionally, in the above-described connector 1 according to the first embodiment, the first control portions 13a and 13b, which are provided in the outer wall portions of the plug connectors 2a and 2b, may be provided in a wall portion forming the opening portion 12 or the wall portion 62 formed in the mount plate 5, or the like. Additionally, the second control portion 16, which is provided in the outer wall portion of the additional plug connector 3, may be provided in the wall portion forming the opening portion 12 or in the wall portion formed in the mount plate 5.

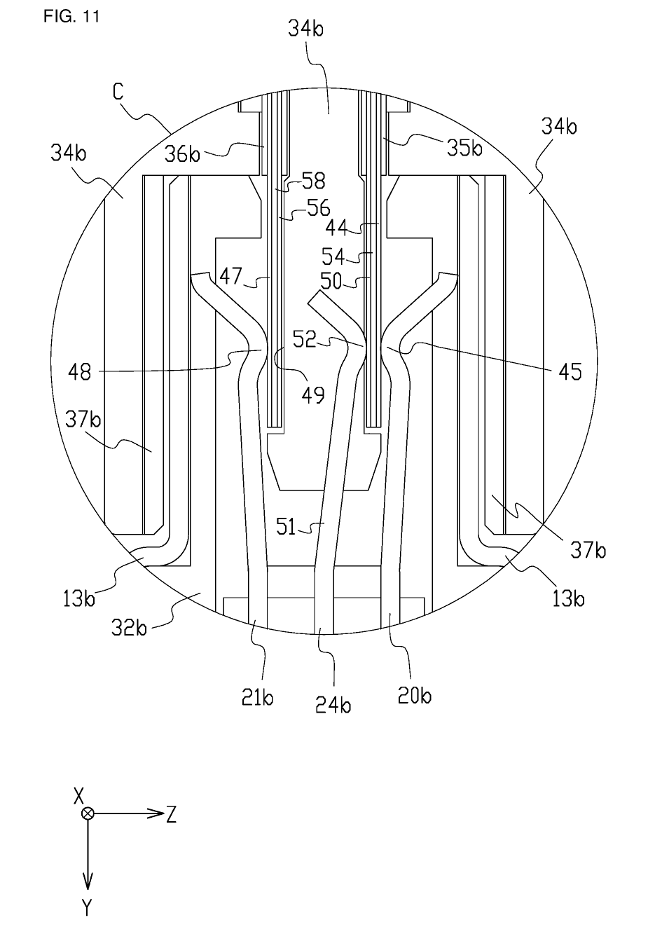

Additionally, in the above-described connector 1 according to the first embodiment, although the first supporting surface 46 and the first shield connection portion 52 are separately configured, the first supporting surface and the first shield connection portion may be integrally formed. Specifically, although the first supporting surface 46 receives a force which pushes the first connection portion 45 to the first conductor 44 (an elastic force of the elastic body), the first shield connection portion 52 may function as a first supporting portion which receives an elastic force of the elastic body. For example, as shown in FIG. 11, the first shield connection portion 52 may be arranged at a position where the force which pushes the first connection portion 45 to the first conductor 44 can be received so that the first shield connection portion 52 functions as the first supporting portion. In this case, however, the third supporting surface 53 and the first connection portion 45 are not configured separately, but the third supporting portion and the first connection portion are integrally formed. Specifically, in place of the third supporting surface 53, the first connection portion 45 functions as the third supporting portion that receives a force which pushes the first shield connection portion 52 to the first shield portion 50 (an elastic force of the first elastic member 51).

Additionally, in the above-described connector 1 according to the first embodiment, although the second supporting surface 49 and the second shield connection portion 57 are separately configured, the second supporting surface and the second shield connection portion may be integrally formed. Specifically, while the second supporting surface 49 receives a force which pushes the second connection portion 48 to the second conductor 47 (an elastic force of the elastic body), the second shield connection portion 57 may function as the second supporting portion which receives the elastic force of the elastic body. For example, the second shield connection portion 57 is arranged at a position where a force which pushes the second connection portion 48 to the second conductor 47 can be received so that the second shield connection portion 57 functions as the second supporting portion. In this case, however, the third supporting surface 60 and the second connection portion 48 are not separately configured, but the third supporting portion and the second connection portion are integrally formed. Specifically, in place of the third supporting surface 60, the second connection portion 48 functions as the third supporting portion that receives a force which pushes the second shield connection portion 57 to the second shield portion 56 (an elastic force of the second elastic members 55).

Additionally, although the above-described connector 1 according to the first embodiment has been described with respect to a case where the first connection portion 45, the first shield connection portion 52, the second connection portion 48, and the second shield connection portion 57 are points, at least one of the first connection portion, the first shield connection portion, the second connection portion, and the second shield connection portion may be a surface. Additionally, at least one of the first connection portion, the first shield connection portion, the second connection portion, and the second shield connection portion is formed of two or more points, or two or more surfaces.

Additionally, although in the above-described connector 1 according to the first embodiment, one additional plug connector 3 is provided, two or more additional plug connectors may be provided.

Additionally, although in the above-described first embodiment, the ground plate 24b is electrically connected with the first shield portion 50 of the first FFC 35b and with the second shield portion 56 of the second FFC 36b, at least one of the first shield portion and the second shield portion needs to be connected.

Additionally, while the above first embodiment has been described with respect to a case where as the first conductor to be connected with the plurality of first contacts 20b and as the second conductor to be connected with the plurality of second contacts 21b, a conductor configuring an FFC is used, other than an FFC, for example, a conductor foil configuring a flexible printed board (FPC) or the like may be used as the first conductor and the second conductor.

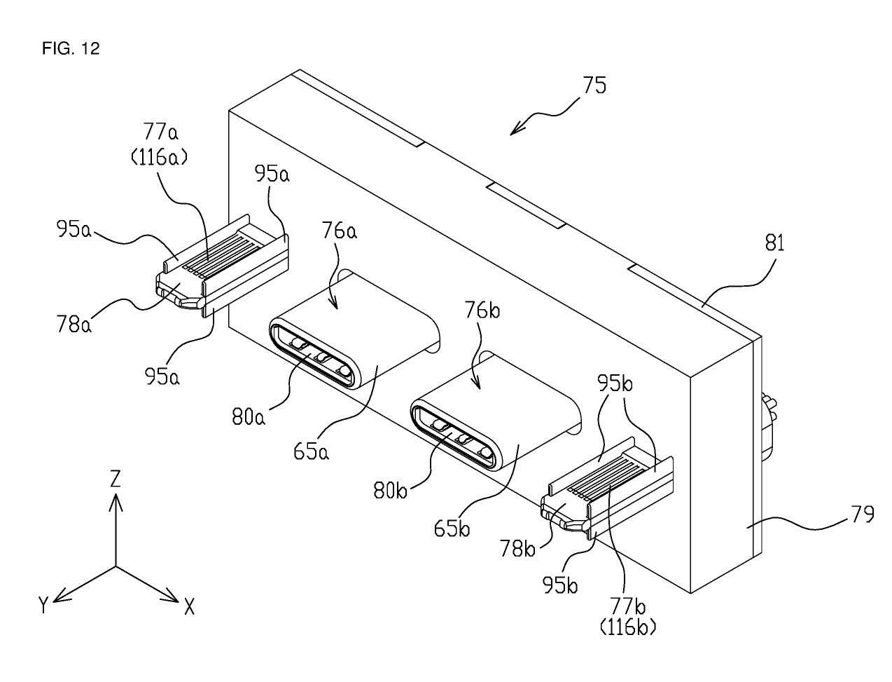

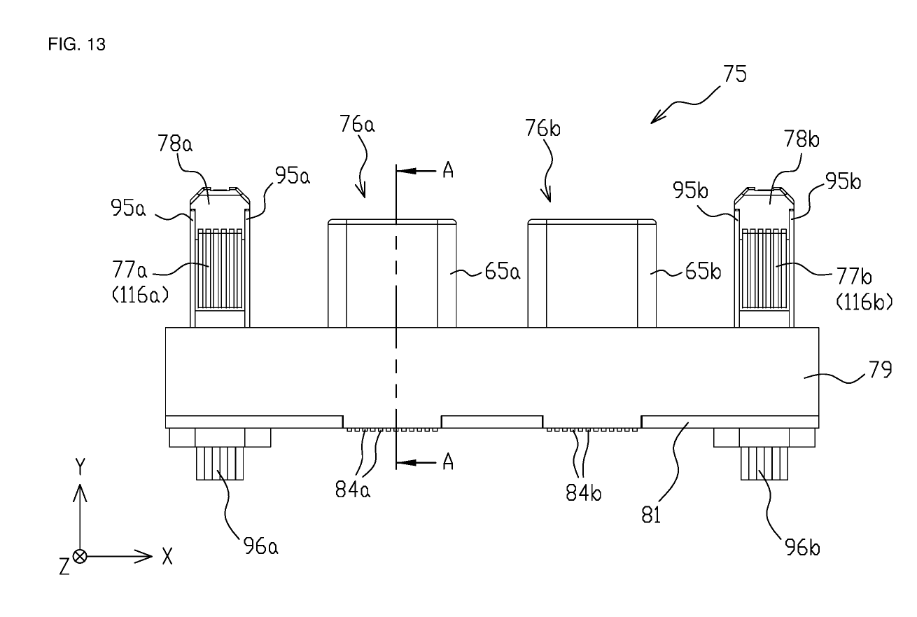

Next, a docking connector according to a second embodiment of the present invention will be described with reference to the drawings. FIG. 12 is a perspective view showing an appearance of a plug docking connector as a plug unit according to the second embodiment, FIG. 13 is a bottom plan view showing the appearance of the plug docking connector according to the second embodiment. As shown in FIG. 12 and FIG. 13, a plug docking connector 75 includes a front cover 79 having two USB Type-C plug connectors (hereinafter, referred to simply as a plug connector) 76a and 76b, two additional plug connectors 77a and 77b, and two guide portions 78a and 78b, and a rear cover 81. The docking connector is a connector for connecting a portable terminal device with an external apparatus, which represents, in a broad sense, such a docking connector as incorporated into an apparatus main body, as housed in a housing or the like and as connected with an apparatus via a cable or the like, or other.

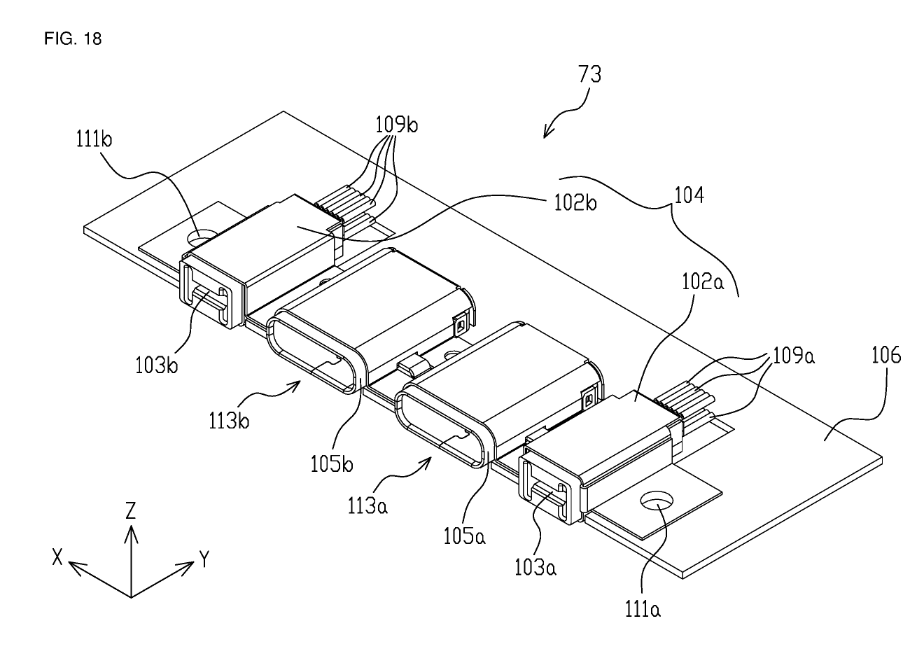

Additionally, in the following, with an XYZ orthogonal coordinate system set as shown in FIG. 12, description will be made of a positional relationship and the like of each member with reference to the orthogonal coordinate system. An X axis is set to be parallel to a direction in which the two plug connectors 76a and 76b are arranged. A Y axis is set to be parallel to a direction in which the plug docking connector 75 is docked with a receptacle docking connector 73 (see FIG. 18). A Z axis is set to be in a direction orthogonal to an YZ plane. Additionally, a side of the plug connector 76b is set to be a +X direction and a side of the plug connector 76a is set to be a −X direction, and a direction in which the plug docking connector 75 is docked with the receptacle docking connector is set to be a +Y direction and a direction in which the plug docking connector 75 is pulled out from the receptacle docking connector is set to be a −Y direction.

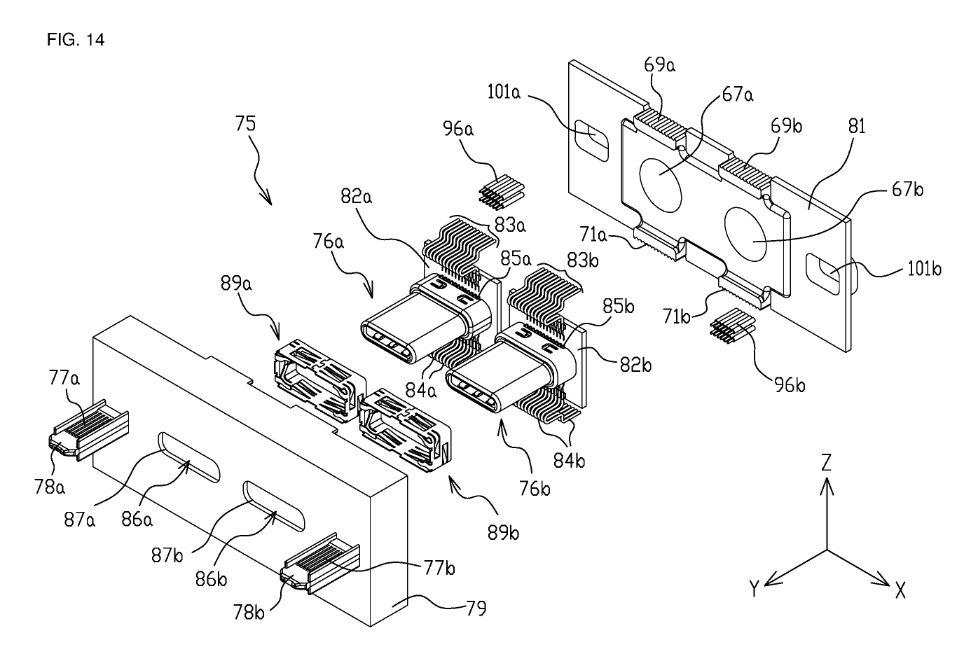

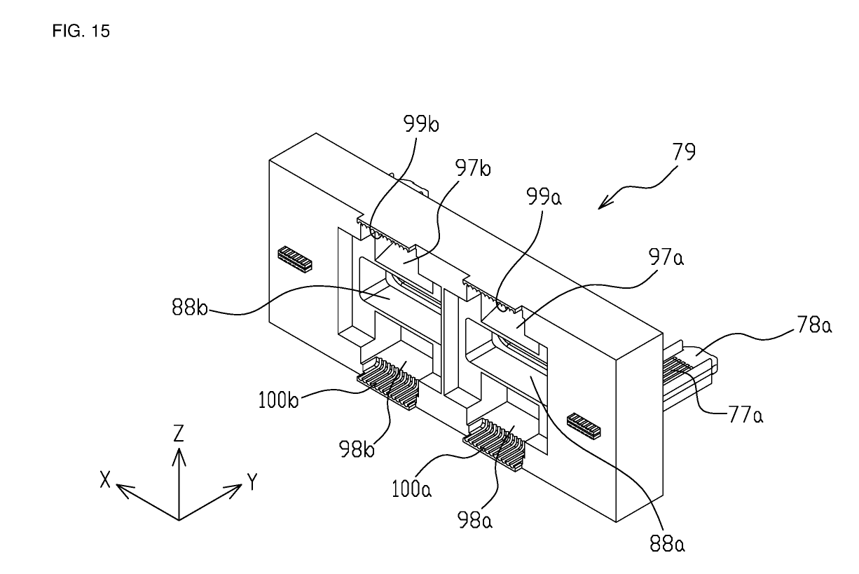

FIG. 14 is an exploded view showing a configuration of the plug docking connector 75, and FIG. 15 is a perspective view showing an appearance of the front cover 79 seen from the −Y direction. As shown in FIG. 12 to FIG. 15, the front cover 79 functions as a cover which covers the plug connectors 76a and 76b.

When docking with the receptacle docking connector 73 including two USB Type-C receptacle connectors (hereinafter, referred to simply as receptacle connectors) 113a and 113b (see FIG. 18), the front cover 79 includes the two guide portions 78a and 78b to be inserted into guide reception portions 102a and 102b (see FIG. 18) of the receptacle docking connector 73 before the plug connectors 76a and 76b fit in the two receptacle connectors 113a and 113b (see FIG. 18). The two guide portions 78a and 78b are formed integrally with the front cover 79, and the front cover 79 and the two guide portions 78a and 78b are formed of resin. The guide portion 78a is formed on the −X direction side of the plug connector 76a, and the guide portion 78b is formed on the +X direction side of the plug connector 76b.

The guide portion 78a has a member 95a with a high strength (metal in this embodiment) insert-molded therein. Similarly, the guide portion 78b has a member 95b with a high strength (metal in this embodiment) insert-molded therein. Insert-molding of the metals 95a and 95b in the guide portions 78a and 78b enables an increase in the guide portions 78a and 78b in strength, and enables breakage of the guide portions 78a and 78b to be prevented when the guide portions 78a and 78b are inserted into the guide reception portions 102a and 102b of the receptacle docking connector 73. The metals 95a and 95b can be incorporated into the guide portions 78a and 78b by fitting-in, embedding and the like other than by insert-molding.

Additionally, front end portions on the +Y direction side of the guide portions 78a and 78b protrude more in the +Y direction than front end portions on the +Y direction side of the plug connectors 76a and 76b. Specifically, the guide portions 78a and 78b protrude more than the plug connectors 76a and 76b to a side of an insertion direction (the +Y direction)in which the guide portions 78a and 78b are inserted into the guide reception portions 102a and 102b of the receptacle docking connector 73. Accordingly, when the plug docking connector 75 docks with the receptacle docking connector 73, the guide portions 78a and 78b are inserted into the guide reception portions 102a and 102b of the receptacle docking connector 73 before the plug connectors 76a and 76b fit in the receptacle connectors 113a and 113b.

Additionally, a width W (mm) of each of the guide portions 78a and 78b in a direction (Z direction) orthogonal to a direction in which the plug connectors 76a and 76b are aligned is equal to or more than an internal diameter width D (mm) in the Z direction of an internal diameter of each of the receptacle connectors 113a and 113b. The width W (mm) of each of the guide portions 78a and 78b preferably satisfies D≦W≦(D+0.6) and more preferably satisfies D≦W≦(D+1). Accordingly, when the plug docking connector 75 docks with the receptacle docking connector 73, erroneous insertion of the guide portions 78a and 78b into the receptacle connectors 113a and 113b can be prevented.

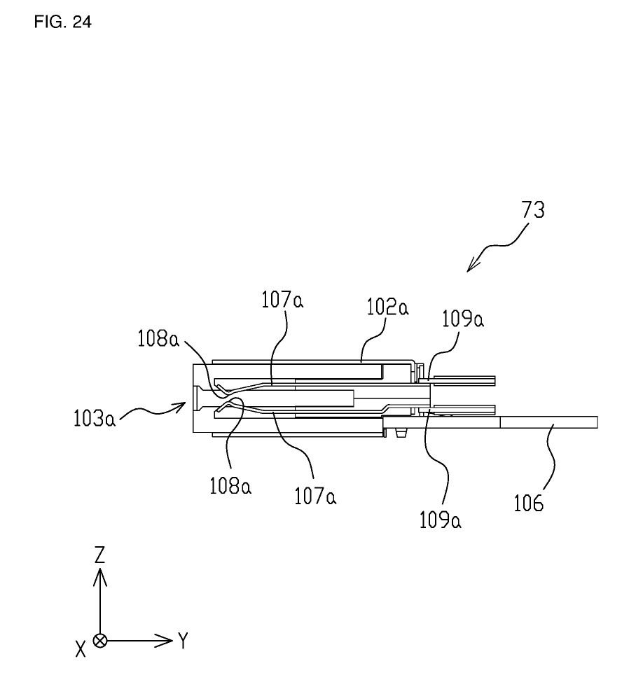

Additionally, the guide portion 78a has the additional plug connector 77a arranged therein, i.e., incorporated, and the additional plug connector 77a includes a plurality of contacts 116a as shown in FIG. 13. The contacts 116a each have a connection surface which connects with a connection terminal 108a of a contact 107a of an additional receptacle connector 103a (see FIG. 24). The connection surface is arranged on a plane substantially flush with a surface on the +Z side of the guide portion 78a. Additionally, the additional plug connector 77a also includes a plurality of contacts (not shown) on a surface on the −Z side of the guide portion 78a. The contacts not shown each have a connection surface which connects with the connection terminal 108a of the contact 107a of the additional receptacle connector 103a (see FIG. 24). The connection surface is arranged on a plane substantially flush with a surface on the −Z side of the guide portion 78a. The contacts 116a and contacts not shown of the additional plug connector 77a are electrically connected with cables 96a shown in FIG. 14.

Additionally, the guide portion 78b has the additional plug connector 77b arranged therein, i.e., incorporated, and the additional plug connector 77b includes a plurality of contacts 116b as shown in FIG. 13. The contacts 116b each have a connection surface which connects with a connection terminal (not shown) of a contact of an additional receptacle connector 103b (see FIG. 18). The connection surface is arranged on a plane substantially flush with a surface on the +Z side of the guide portion 78b. Additionally, the additional plug connector 77b also includes a plurality of contacts (not shown) on a surface on the −Z side of the guide portion 78b. The contacts not shown each have a connection surface which connects with a connection terminal (not shown) of a contact 107b of the additional receptacle connector 103b. The connection surface is arranged on a plane substantially flush with a surface on the −Z side of the guide portion 78b. The contacts 116b and contacts not shown of the additional plug connector 77b are electrically connected with cables 96b shown in FIG. 14.

Additionally, on the −X direction side between the guide portion 78a and the guide portion 78b of the front cover 79, an opening portion 86a is formed which covers the plug connector 76a and is for exposing a fit-in portion 80a at which the plug connector 76a fits in the receptacle connector 113a (see FIG. 18). Additionally, on the +X direction side between the guide portion 78a and the guide portion 78b of the front cover 79, an opening portion 86b is formed which covers the plug connector 76b and is for exposing a fit-in portion 80b at which the plug connector 76b fits in the receptacle connector 113b (see FIG. 18).

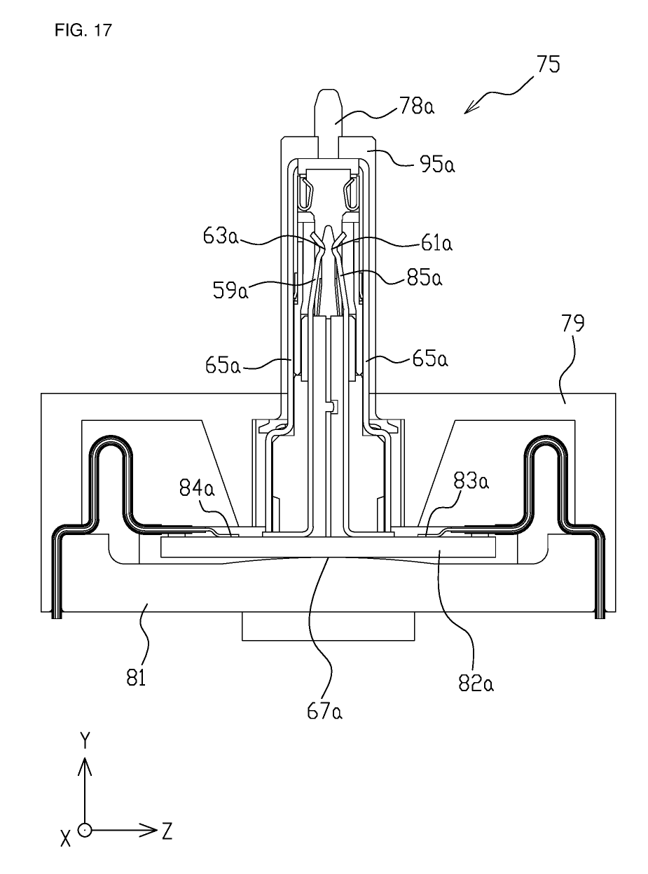

Additionally, in the front cover 79 (the rear of a surface on which the guide portions 78a and 78b are formed), as shown in FIG. 15, cable housing portions 97a and 98a are formed on the −X direction side, and cable housing portions 97b and 98b are formed on the +X direction side. The cable housing portion 97a is located on the +Z direction side to house a cable 83a (see FIG. 17). The cable housing portion 98a is located on the −Z direction side to house a cable 84a (see FIG. 17). The cable housing portion 97b is located on the +Z direction side to house a cable 83b (see FIG. 14). The cable housing portion 98b is located on the −Z direction side to house a cable 84b (see FIG. 14).

Further, in the front cover 79 (the rear of a surface on which the guide portions 78a and 78b are formed), as shown in FIG. 15, cable holding portions 99a and 100a are formed on the −X direction side, and cable holding portions 99b and 100b are formed on the +X direction side. The cable holding portion 99a is located on the +Z direction side and holds the cable 83a (see FIG. 14), together with a cable holding portion 69a of the rear cover 81 (see FIG. 14). The cable holding portion 100a is located on the −Z direction side and holds the cable 84a (see FIG. 14), together with a cable holding portion 71a of the rear cover 81 (see FIG. 14). The cable holding portion 99b is located on the +Z direction side and holds the cable 83b (see FIG. 14), together with a cable holding portion 69b of the rear cover 81 (see FIG. 14). The cable holding portion 100b is located on the −Z direction side and holds the cable 84b (see FIG. 14), together with a cable holding portion 71b of the rear cover 81 (see FIG. 14). The cable holding portions 99a, 99b, 100a, and 100b function as second holding portions which hold the cables 83a, 83b, 84a, and 84b, respectively, together with the cable holding portions 69a, 69b, 71a, and 71b of the rear cover 81 which will be described later. The second holding portion will be detailed later.

Additionally, between an outer wall portion of the plug connector 76a, i.e., a plug shell 65a which will be described later, and a wall portion 87a formed on the +Y direction side of the opening portion 86a, a predetermined space is formed such that on a surface on which the opening portion 86a is formed (ZX plane), the plug connector 76a can move relative to the front cover 79 (the rear cover 81 fixed to the front cover 79) as shown in FIG. 12. Similarly, between an outer wall portion of the plug connector 76b, i.e. a plug shell 65b which will be described later, and a wall portion 87b formed on the +Y direction side of the opening portion 86b, a predetermined space is formed such that on a surface on which the opening portion 86b is formed (ZX plane), the plug connector 76b can move relative to the front cover 79 (the rear cover 81 fixed to the front cover 79).

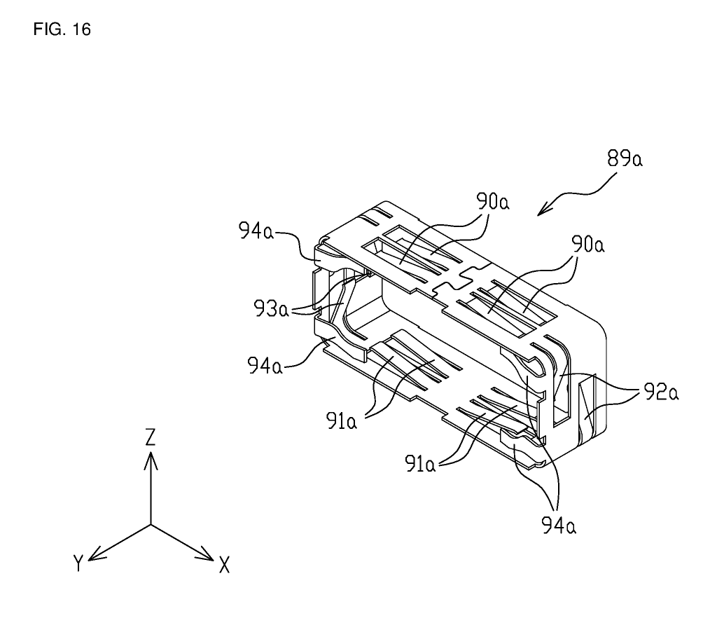

Between the outer wall portion of the plug connector 76a and the front cover 79 (a wall portion 88a formed on the −Y direction side of the opening portion 86a), a control portion 89a is provided. FIG. 16 is a view showing a configuration of the control portion 89a. The control portion 89a is formed of a conductive member, e.g., metal, and on the +Z direction side of the control portion 89a, as shown in FIG. 16, four Z side elastic portions 90a are formed. Additionally, on the −Z direction side of the control portion 89a, four Z side elastic portions 91a are formed. The control portion 89a is incorporated into the opening portion 86a, and the Z side elastic portion 90a pushes the outer wall portion on the +Z direction side of the plug connector 76a toward the −Z direction by an elastic force. The outer wall portion on the +Z direction side of the plug connector 76a receives the elastic force of the Z side elastic portion 90a. The Z side elastic portion 91a pushes the outer wall portion on the −Z direction side of the plug connector 76a toward the +Z direction by an elastic force. The outer wall portion on the −Z side of the plug connector 76a receives an elastic force of the Z side elastic portion 91a.

The control portion 89a controls a position of the plug connector 76a in the Z direction relative to the opening portion 86a by using elastic forces of the Z side elastic portions 90a and 91a. For example, when a force in the −Z direction is applied to the plug connector 76a, the Z side elastic portion 90a extends in the −Z direction and the Z side elastic portion 91a contracts in the −Z direction. Accordingly, the plug connector 76a moves in the −Z direction within a predetermined space formed between the outer wall portion of the plug connector 76a and the wall portion 88a. When a force in the +Z direction is applied to the plug connector 76a, the Z side elastic portion 90a contracts in the +Z direction, and the Z side elastic portion 91a extends in the +Z direction. Accordingly, the plug connector 76a moves in the +Z direction within the predetermined space formed between the outer wall portion of the plug connector 76a and the wall portion 88a.

Additionally, on the +X direction side of the control portion 89a, as shown in FIG. 16, two X side elastic portions 92a are formed. Additionally, on the −X direction side of the control portion 89a, two X side elastic portions 93a are formed. The X side elastic portion 92a pushes the outer wall portion on the +X direction side of the plug connector 76a toward the −X direction by an elastic force. The outer wall portion on the +X direction side of the plug connector 76a receives the elastic force of the X side elastic portion 92a. The X side elastic portion 93a pushes the outer wall portion on the −X direction side of the plug connector 76a toward the +X direction by an elastic force. The outer wall portion on the −X direction side of the plug connector 76a receives the elastic force of the X side elastic portion 93a.

The control portion 89a controls a position of the plug connector 76a in the X direction relative to the opening portion 86a by using elastic forces of the X side elastic portions 92a and 93a. For example, when a force in the −X direction is applied to the plug connector 76a, the X side elastic portion 92a extends in the −X direction, and the X side elastic portion 93a contracts in the −X direction. Accordingly, the plug connector 76a moves in the −X direction within the predetermined space formed between the outer wall portion of the plug connector 76a and the wall portion 88a. When a force in the +X direction is applied to the plug connector 76a, the X side elastic portion 92a contracts in the +X direction, and the X side elastic portion 93a extends in the +X direction. Accordingly, the plug connector 76a moves in the +X direction within the predetermined space formed between the outer wall portion of the plug connector 76a and the wall portion 88a.

Additionally, on the +Y direction side of the control portion 89a, as shown in FIG. 16, four Y side elastic portions 94a are formed. The control portion 89a controls a posture of the plug connector 76a relative to the opening portion 86a by using the Y side elastic portion 94a and a convex portion 67a formed in the rear cover 81 (see FIG. 14). Posture control of the control portion 89a will be detailed later.

Additionally, between the outer wall portion of the plug connector 76b and the front cover 79 (a wall portion 88b formed on the −Y direction side of the opening portion 86b), a control portion 89b is provided. The control portion 89b is formed of a conductive member, e.g., metal, and is incorporated in the opening portion 86b. On the +Z direction side of the control portion 89b, four Z side elastic portions are formed which have the same function and effect as those of the Z side elastic portion 90a of the control portion 89a. Additionally, on the −Z direction side of the control portion 89b, four Z side elastic portions are formed which have the same function and effect as those of the Z side elastic portion 91a of the control portion 89a.

Additionally, on the +X direction side of the control portion 89b, two X side elastic portions are formed which have the same function and effect as those of the X side elastic portion 92a of the control portion 89a. Additionally, on the −X direction side of the control portion 89b, two X side elastic portions are formed which have the same function and effect as those of the X side elastic portion 93a of the control portion 89a. Additionally, on the +Y direction side of the control portion 89b, four Y side elastic portions are formed which have the same function and effect as those of the Y side elastic portion 94a of the control portion 89a. Since position control and posture control of the plug connector 76b of the control portion 89b are the same as the position control and the posture control of the plug connector 76a in the control portion 89a, no description will be made thereof.

Next, a configuration of the plug connector 76a will be described. FIG. 17 is a sectional view taken along A-A in FIG. 13. The plug connector 76a is mounted on a circuit board 82a as shown in FIG. 14 and FIG. 17. As shown in FIG. 17, the plug connector 76a includes a plurality of contacts 85a and a plurality of contacts 59a which connect with a plurality of contacts (not shown) of the receptacle connectors 113a and 113b (see FIG. 18), and the plug shell 65a covering the plurality of contacts 85a and 59a. Each of the plurality of contacts 85a is arranged on the +Z direction side of the plug connector 76a, and an end portion on the −Y direction side of the contact 85a is fixed to the circuit board 82a by soldering or the like. Additionally, each of the plurality of contacts 85a includes a contact portion 61a at an end portion thereof on the +Y direction side, the contact portion 61a for coming into contact with the contacts (not shown) of the receptacle connectors 113a and 113b (see FIG. 18). Each of the plurality of contacts 59a is arranged on the −Z direction side of the plug connector 76a, and an end portion on the −Y direction side of the contact 59a is fixed to the circuit board 82a by soldering or the like. Additionally, each of the plurality of contacts 59a includes a contact portion 63a at an end portion thereof on the +Y direction side, the contact portion 63a for coming into contact with the contacts (not shown) of the receptacle connectors 113a and 113b.

Additionally, on the +Z direction side of the circuit board 82a, one end of each of the plurality of cables 83a is fixed by soldering or the like. Each of the plurality of cables 83a is electrically connected with each of the plurality of contacts 85a arranged on the +Z direction side of the plug connector 76a via the circuit board 82a. Additionally, to the −Z direction side of the circuit board 82a, one end of each of the plurality of cables 84a is fixed by soldering or the like. Each of the plurality of cables 84a is electrically connected with each of the plurality of contacts 59a arranged on the −Z direction side of the plug connector 76a via the circuit board 82a.

Next, a configuration of the plug connector 76b will be described. The plug connector 76b is mounted on a circuit board 82b as shown in FIG. 14. Additionally, the plug connector 76b includes a plurality of contacts not shown and the plug shell 65b (see FIG. 12). Configurations of these contacts and the shell are line-symmetrically the same as those of the plurality of contacts 85a and 59a and the plug shell 65a, i.e., with respect to a center line in the Y axis direction of the plug docking connector 75. Additionally, on the +Z direction side of the circuit board 82b, one end of each of the plurality of cables 83b is fixed by soldering or the like. Each of the plurality of cables 83b is electrically connected with each of a plurality of contacts 85b arranged on the +Z direction side of the plug connector 76b. Additionally, on the −Z direction side of the circuit board 82b, one end of the plurality of cables 84b is fixed by soldering or the like. Each of the plurality of cables 84b is electrically connected with each of a plurality of contacts (not shown) arranged on the −Z direction side of the plug connector 76b.

Here, the circuit boards 82a and 82b on which the plug connectors 76a and 76b are mounted function as first holding portions which hold one ends of the plurality of cables 83a, 84a, 83b and 84b, respectively, because one ends of the plurality of cables 83a, 84a, 83b and 84b are fixed to the circuit boards 82a and 82b, respectively. The first holding portion will be detailed later.

Next, a configuration of the rear cover 81 will be described. As shown in FIG. 12, the rear cover 81 is attached and fixed to the front cover 79 to support the plug connectors 76a and 76b from the −Y direction side. As shown in FIG. 14, on the −X direction side of the rear cover 81, an opening portion 101a is formed for leading the cable 96a from a space formed between the front cover 79 and the rear cover 81 to the outside. The cable 96a is fixed in the opening portion 101a by an adhesive not shown or the like. Additionally, on the +X direction side of the rear cover 81, an opening portion 101b is formed for leading the cable 96b from the space formed between the front cover 79 and the rear cover 81 to the outside. The cable 96b is fixed in the opening portion 101b by an adhesive not shown or the like.

Additionally, on a surface on the +Y direction side of the rear cover 81, the convex portion 67a as a part of the configuration of the control portion 89a, and a convex portion 67b as a part of the configuration of the control portion 89b are formed. The two convex portions 67a and 67b each have a convex surface on the +Y direction side, and the convex portion 67a is arranged on the +X direction side of the rear cover 81 to support the plug connector 76a in the +Y direction. The convex portion 67b is arranged on the −X direction side of the rear cover 81 to support the plug connector 76b in the +Y direction.

Using the Y side elastic portion 94a (see FIG. 16) and the convex portion 67a (see FIG. 14), the control portion 89a controls a posture of the plug connector 76a relative to the opening portion 86a, i.e. an inclination relative to the Y axis direction. For example, applying, to the plug connector 76a, a force in a direction slanting relative to the Y axis direction changes a direction in which the convex portion 67a supports the plug connector 76a and an elastic force of the Y side elastic portion 94a. Then, the posture of the plug connector 76a changes to a direction in which a force is applied in a predetermined space formed between the plug shell 65a and the wall portion 87a. Specifically, the plug connector 76a slants relative to a surface on which the opening portion 86a is formed. The Y side elastic portion 94a arranged on the side to which the plug connector 76a slants functions as a correction portion which uses an elastic force thereof to push the plug connector 76a, thereby correcting an inclination of the plug connector 76a. When the force applied to the plug connector 76a is released, by the elastic force of the Y side elastic portion 94a, the plug connector 76a returns to a posture as of before the force is applied to the plug connector 76a.

Additionally, in the rear cover 81, on a side portion on the +Z direction side, the cable holding portions 69a and 69b are formed, and on a side portion on the −Z direction side, the cable holding portions 71a and 71b are formed as shown in FIG. 14. The cable holding portion 69a is located on the −X direction side to support the cable 83a together with the cable holding portion 99a of the front cover 79 (see FIG. 15). The cable holding portion 69b is located on the +X direction side to support the cable 83b together with the cable holding portion 99b of the front cover 79 (see FIG. 15). The cable holding portion 71a is located on the −X direction side to hold the cable 84a together with the cable holding portion 100a of the front cover 79 (see FIG. 15). The cable holding portion 71b is located on the +X direction side to hold the cable 84b together with the cable holding portion 100b (see FIG. 15). The cable holding portions 69a, 69b, 71a, and 71b function as the second holding portions which hold the cables 83a, 83b, 84a, and 84b, together with the cable holding portions 99a, 99b, 100a, and 100b of the front cover 79 respectively.

In the second embodiment, the cable 83a, 83b, 84a and 84b (see FIG. 14) have a flexible portion which follows movement of the plug connector 76a, the flexible portion being housed in the cable housing portion 97a, 97b, 98a and 98b (see FIG. 15) between the circuit boards 82a and 82b (see FIG. 14) as the first holding portions and the cable holding portions 99a, 99b, 100a and 100b (see FIG. 15) and the cable holding portions 69a, 69b, 71a and 71b (see FIG. 14) as the second holding portions. The circuit board 82a and 82b are fixed to the plug connector 76a and 76b and function as the first holding portions which hold one ends of the cable 83a, 83b, 84a and 84b as flexible portions. The cable holding portions 99a, 99b, 100a and 100b of the front cover 79 and the cable holding portions 69a, 69b, 71a and 71b of the rear cover 81 are provided at the front cover 79 and the rear cover 81 as the covers, respectively, and function as the second holding portions which hold the other ends of the cables 83a, 83b, 84a and 84b as the flexible portions.

Provision of the flexible portion, the first holding portion and the second holding portion allows the plug connector 76a to move relative to the front cover 79 and the rear cover 81 without being restricted by other member. The flexible portion need not necessarily to be the cable 83a and can be the contact 85a of the plug connector 76a, for example. Additionally, the first holding portion need not to be the circuit board 82a and can be the plug connector 76a, for example.

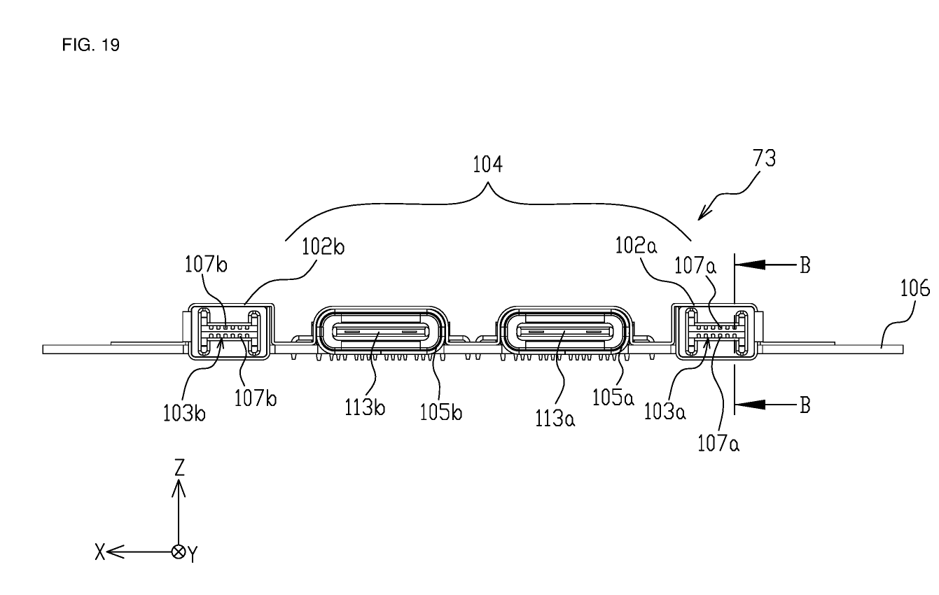

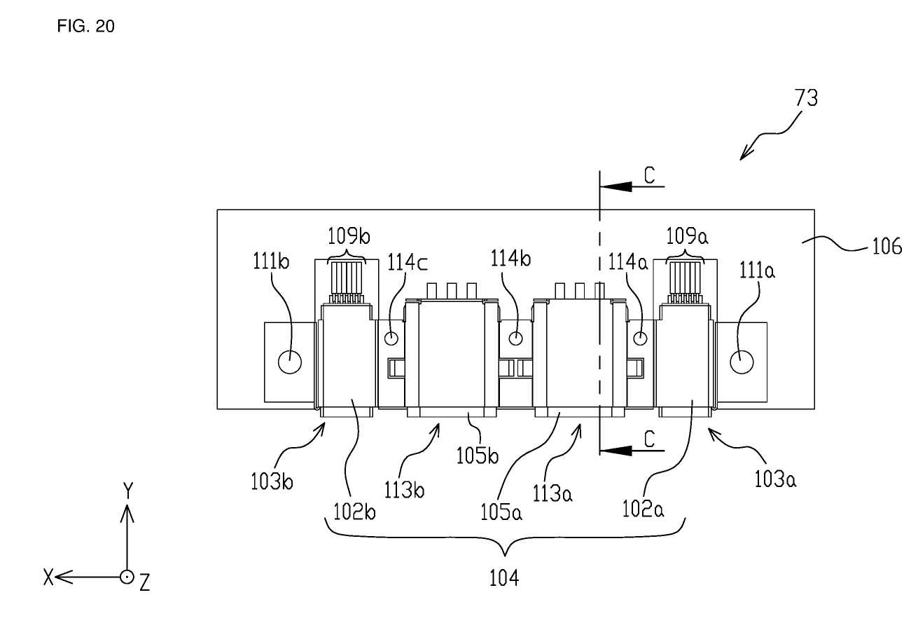

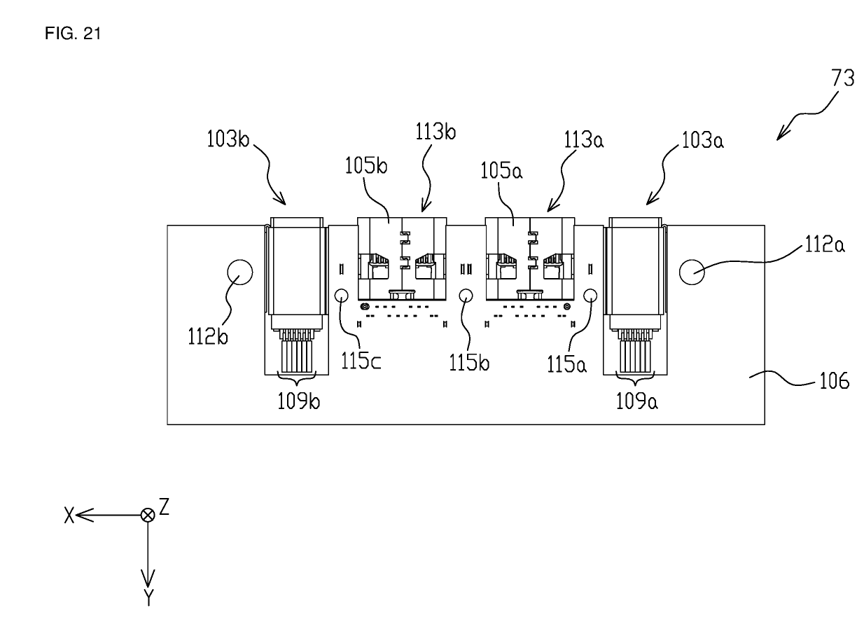

Next, description will be made of a docking connector on a receptacle side (hereinafter, referred to as a receptacle docking connector) as a receptacle unit according to the second embodiment of the present invention with reference to the drawings. FIG. 18 is a perspective view showing an appearance of a receptacle docking connector according to the second embodiment, FIG. 19 is a front view showing the appearance of the receptacle docking connector according to the second embodiment, FIG. 20 is a plan view showing the appearance of the receptacle docking connector according to the second embodiment, and FIG. 21 is a bottom plan view showing the appearance of the receptacle docking connector according to the second embodiment. The receptacle docking connector 73 is mounted on a portable terminal device (electronic apparatus) such as a tablet type PC or the like, and as shown in FIG. 18, includes a guide shell 104 having the two receptacle connectors 113a and 113b, the two additional receptacle connectors 103a and 103b, and the two guide reception portions 102a and 102b.

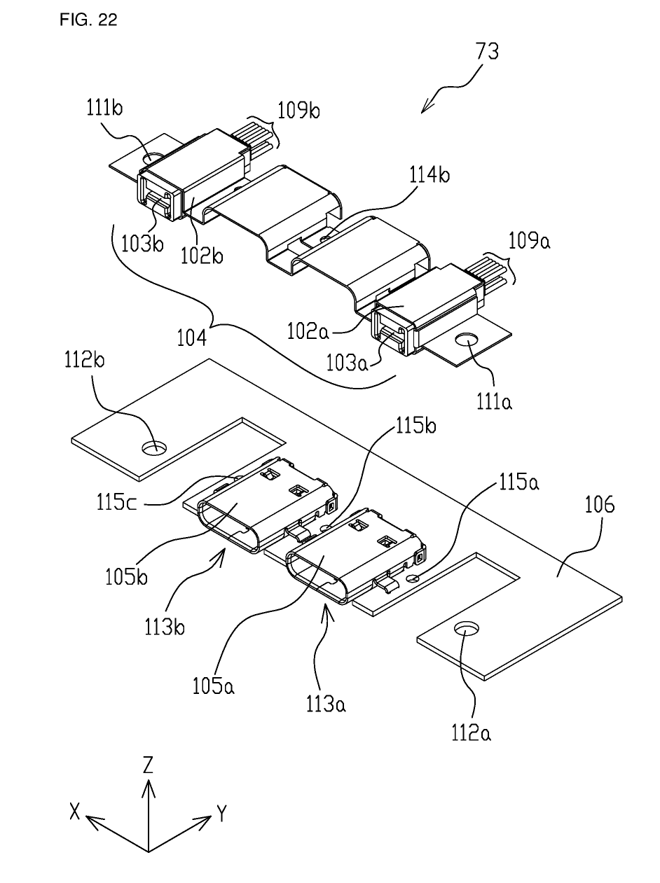

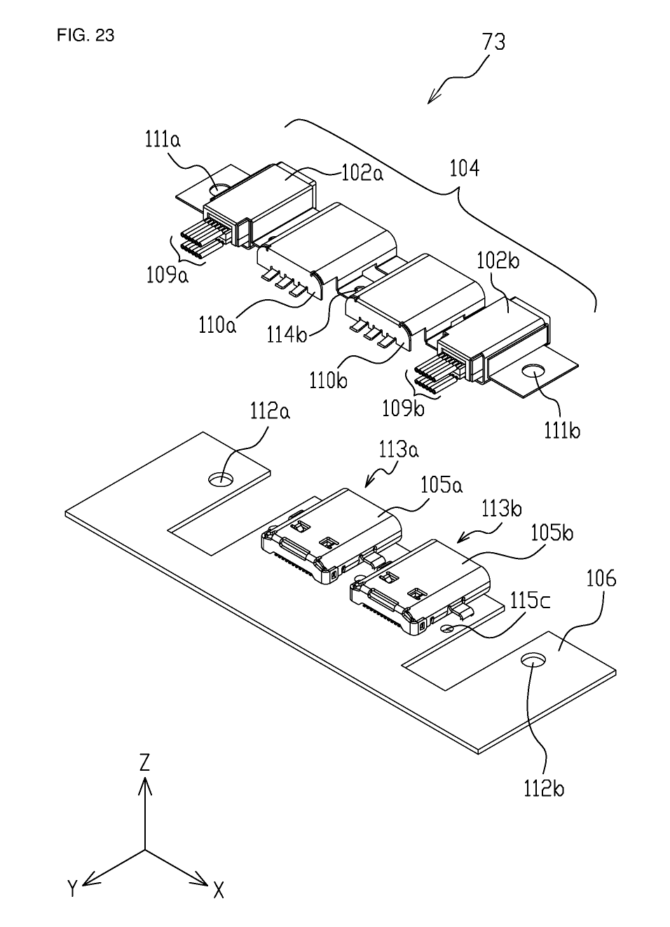

FIG. 22 and FIG. 23 are exploded views for explaining a configuration of the receptacle docking connector 73, FIG. 22 as a perspective view seen from the front side and FIG. 23 as a perspective view seen from the back side. The receptacle connector 113a includes a receptacle shell 105a which engages with the plug connector 76a (see FIG. 12) and as shown in FIG. 19, covers a contact and the like (not shown) provided in the receptacle connector 113a. The receptacle connector 113b includes a receptacle shell 105b which engages with the plug connector 76b (see FIG. 12) and as shown in FIG. 19, covers a contact and the like (not shown) provided in the receptacle connector 113b.

The receptacle connectors 113a and 113b are mounted on a mounting surface (a surface on the +Z direction side) of a board 106 such that an engagement direction (Y direction) as a direction of engagement with the plug connectors 76a and 76b and the mounting surface are parallel to each other. Additionally, the receptacle connectors 113a and 113b are mounted on the board 106 individually. Specifically, the receptacle connector 113a is mounted on the board 106 independently of the receptacle connector 113b. Although in the second embodiment, the two receptacle connectors 113a and 113b are provided, three or more receptacle connectors can be provided. Additionally, when three or more receptacle connectors are provided, at least one receptacle connector of the three or more receptacle connectors is mounted on the board 106 independently of at least one other receptacle connector. For example, when three receptacle connectors are provided, each receptacle connector is individually mounted on the board 106, or two receptacle connectors are integrally mounted on the board 106 and one receptacle connector is mounted on the board 106 independently of the other two receptacle connectors.

The additional receptacle connector 103a is located on the −X direction side of the receptacle docking connector 73 and is arranged within the guide reception portion 102a as shown in FIG. 18. FIG. 24 is a sectional view taken along B-B in FIG. 19. The additional receptacle connector 103a includes a plurality (12 in the second embodiment) of contacts 107a as shown in FIG. 19 and FIG. 24. At one end portion of the contact 107a, the connection terminal 108a as an elastic body is formed which connects with the contact 116a and a contact not shown of the additional plug connector 77a, as shown in FIG. 24. The other end portion of the contact 107a is electrically connected with a wire 109a as shown in FIG. 24.

The additional receptacle connector 103b is located on the +X direction side of the receptacle docking connector 73 and is arranged within the guide reception portion 102b as shown in FIG. 18. The additional receptacle connector 103b includes a plurality (12 in the second embodiment) of contacts 107b. At one end portion of the contact 107b, a connection terminal (not shown) as an elastic body is formed which connects with the contact 116b and a contact not shown of the additional plug connector 77b similarly to the contact 107a of the additional receptacle connector 103a. The other end portion of the contact 107b is electrically connected with a wire 109b.

In the above second embodiment, description has been made of a case where the plug connector 76a is engaged with the receptacle connector 113a and the plug connector 76b is engaged with the receptacle connector 113b. In this case, the additional receptacle connector 103a engages with the additional plug connector 77a, and the additional receptacle connector 103b engages with the additional plug connector 77b. However, the plug docking connector 75 and the receptacle docking connector 73 according to the second embodiment are reversible connectors, and also the receptacle connector 113a can be engaged with the plug connector 76b and the receptacle connector 113b can be engaged with the plug connector 76a. In this case, the additional receptacle connector 103a and the additional plug connector 77b engage with each other and the additional receptacle connector 103b engages with the additional plug connector 77a.

Next, a configuration of the guide shell 104 will be described. The guide shell 104 is formed of metal or the like and includes the guide reception portion 102a and the additional receptacle connector 103a arranged in the −X direction side, and the guide reception portion 102b and the additional receptacle connector 103b arranged in the +X direction side. Specifically, the guide reception portions 102a and 102b integrally formed. As shown in FIG. 18, the guide shell 104 covers outer circumferences on the +Z direction side of the receptacle connectors 113a and 113b.

Additionally, as shown in FIG. 23, the guide shell 104 includes supporting portions 110a and 110b which support the receptacle connectors 113a and 113b in the insertion direction (the +Y direction) in which the guide portions 78a and 78b (see FIG. 12) are inserted into the guide reception portions 102a and 102b. As shown in FIG. 23, the guide shell 104 (the supporting portions 110a and 110b) covers the outer circumferences on the +Y direction side of the receptacle connectors 113a and 113b. The supporting portions 110a and 110b receive a force applied to the +Y direction when the guide portions 78a and 78b are inserted into the guide reception portions 102a and 102b. Additionally, the supporting portions 110a and 110b prevent coming-off of the receptacle connectors 113a and 113b from the board 106.

Additionally, the guide shell 104 is provided with a hole 111a for allowing a screw to pass to the −X direction side in the vicinity of the additional receptacle connector 103a, and a hole 111b for allowing a screw to pass to the +X direction side in the vicinity of the additional receptacle connector 103b. Additionally, the guide shell 104 is provided with a hole 114a for allowing a screw to be inserted between the additional receptacle connector 103a and the receptacle connector 113a, a hole 114b for allowing a screw to be inserted between the receptacle connector 113a and the receptacle connector 113b, and a hole 114c for allowing a screw to be inserted between the receptacle connector 113b and the additional receptacle connector 103b. The holes 111a, 111b, and 114a to 114c function as fixing portions for fixing the guide shell 104 to a casing of a portable terminal device. The guide shell 104 and the board 106 are screwed to the casing (not shown) of the portable terminal device by inserting a screw into the hole 111a and a hole 112a formed in the board 106, inserting a screw into the hole 111b and a hole 112b formed in the board 106, inserting a screw into the hole 114a and a hole 115a formed in the board 106, inserting a screw into the hole 114b and a hole 115b formed in the board 106, and inserting a screw into the hole 114c and a hole 115c formed in the board 106. Specifically, the guide shell 104 is fixed to the casing together with the board 106 after the receptacle connectors 113a and 113b are mounted on the board 106. At this time, the guide shell 104 is attached to the casing of the portable terminal device from a position (the +Z direction side) opposed to the mounting surface (the surface on the +Z direction side) of the board 106.

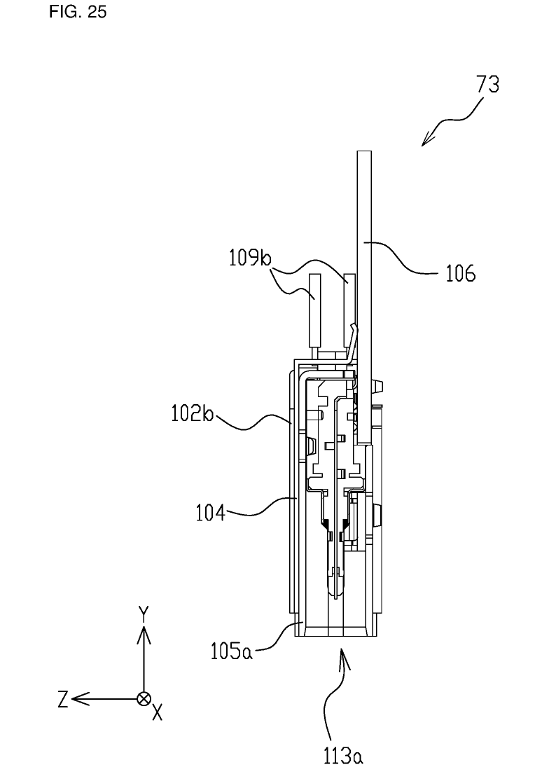

FIG. 25 is a sectional view taken along C-C in FIG. 20. The guide shell 104 and the receptacle shell 105a of the receptacle connector 113a electrically conduct with each other as shown in FIG. 25. Similarly, the guide shell 104 and the receptacle shell 105b of the receptacle connector 113b electrically conduct with each other.

With the plug docking connector 75 according to the second embodiment provided with the guide portions 78a and 78b, the guide portions 78a and 78b are inserted into the guide reception portions 102a and 102b of the receptacle docking connector 73 before the plug connectors 76a and 76b engage with the receptacle connectors 113a and 113b. Accordingly, the plug connectors 76a and 76b can be securely engaged with the receptacle connectors 113a and 113b without damages.

Additionally, with the plug docking connector 75 according to the second embodiment provided with the control portions 89a and 89b, the plug connectors 76a and 76b are connected with the cables 83a, 83b, 84a, and 84b (flexible portions) via the circuit boards 82a and 82b, and the flexible portion is held by the first holding portion and the second holding portion. Accordingly, the positions and the postures of the plug connectors 76a and 76b can be controlled. Specifically, since the plug connectors 76a and 76b are configured to be movable within a predetermined space, a tolerance can be minimized and the plug connectors 76a and 76b can be securely engaged with the receptacle connectors 113a and 113b without damages. Additionally, when not engaged with the receptacle connectors 113a and 113b, the plug connectors 76a and 76b can be maintained at a predetermined position and in a predetermined posture by position control and posture control by the control portions 89a and 89b. Specifically, deviation in a position and a posture of the plug connectors 76a and 76b at the time of mounting can be securely absorbed.

Additionally, with the receptacle docking connector 73 according to the second embodiment provided with the guide reception portions 102a and 102b, the guide portions 78a and 78b are inserted into the guide reception portions 102a and 102b before the plug connectors 76a and 76b engage with the receptacle connectors 113a and 113b. Accordingly, the plug connectors 76a and 76b can be securely engaged with the receptacle connectors 113a and 113b without damages.

Additionally, with the receptacle docking connector 73 according to the second embodiment, the receptacle connectors 113a and 113b are individually mounted on the board 106 and thereafter, at the time of attaching the board 106 to the casing of the portable terminal device, the guide shell 104 is attached together with the board 106. Accordingly, flatness (coplanarity) of the receptacle docking connector 73 with respect to the mounting surface of the board 106 can be excellently maintained to prevent a soldering failure due to poor flatness.

Additionally, with the receptacle docking connector 73 according to the second embodiment, the guide shell 104 covers the receptacle connectors 113a and 113b, and the guide shell 104 and the receptacle shells 105a and 105b electrically conduct with each other. Accordingly, while the receptacle shells 105a and 105b function as inner shells of the receptacle connectors 113a and 113b, the guide shell 104 is allowed to function as an outer shell of the receptacle connectors 113a and 113b. Additionally, since the guide shell 104 covers the receptacle connectors 113a and 113b, and is fixed to the board 106, coming-off of the receptacle connectors 113a and 113b from the board 106 must be prevented.

Additionally, although when a connector is further added to a docking connector having predetermined standard connectors such as a plurality of connectors conforming to the standard specification, there occurs a problem of increasing the docking connector in size, the plug docking connector 75 according to the second embodiment enables down-sizing thereof because the additional plug connectors 77a and 77b are arranged in the guide portions 78a and 78b. Similarly, the receptacle docking connector 73 according to the second embodiment enables down-sizing thereof because the additional receptacle connectors 103a and 103b are arranged in the guide reception portions 102a and 102b.

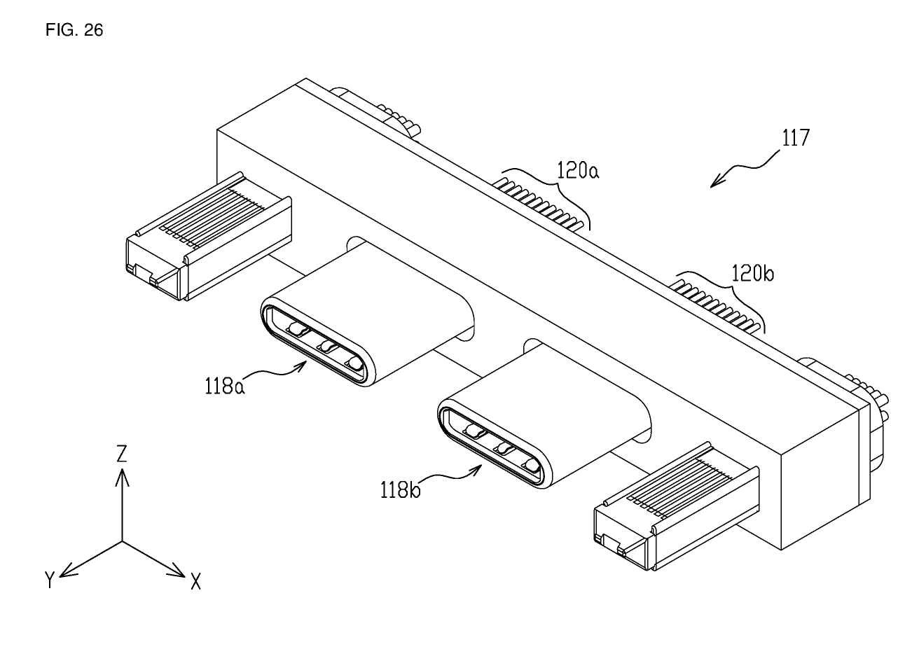

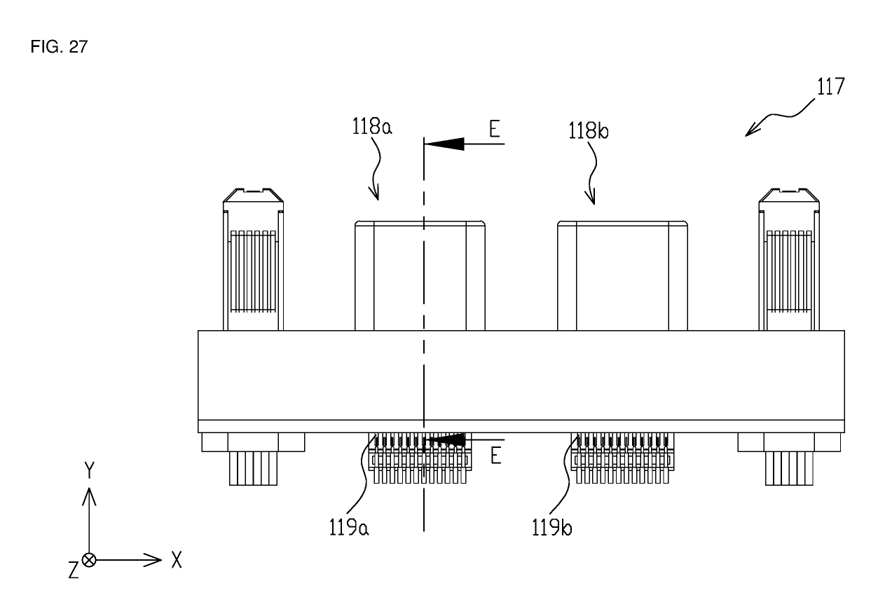

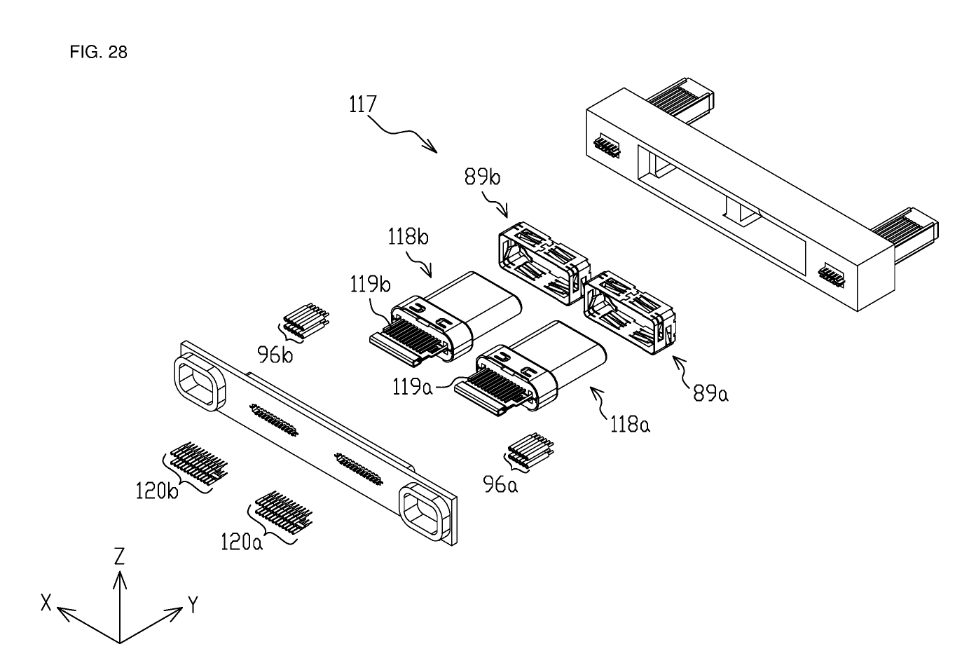

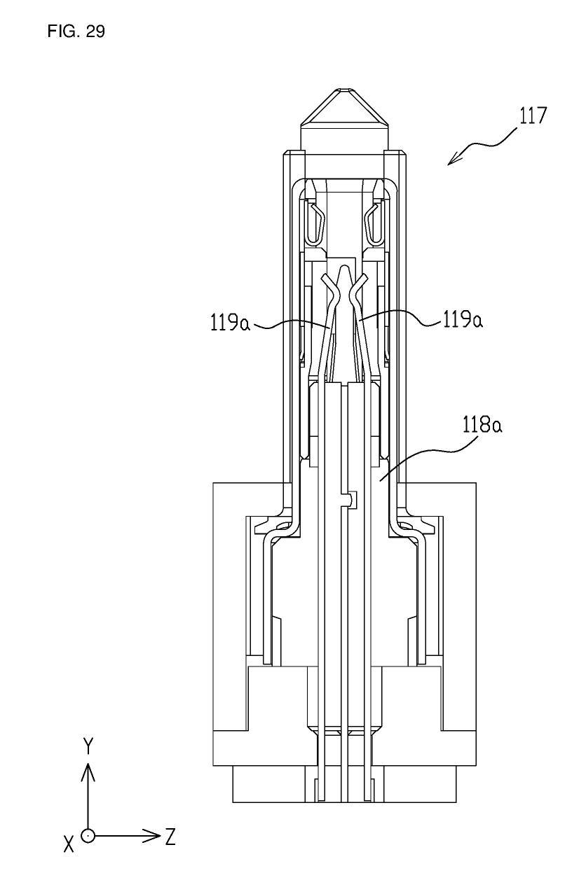

In the above plug docking connector 75 according to the second embodiment, the plug connectors 76a and 76b are mounted on the circuit boards 82a and 82b, and the contacts 85a, 59a, and 85b of the plug connectors 76a and 76b, and the cables 83a, 83b, 84a, and 84b are electrically connected with each other via the circuit boards 82a and 82b. However, in place of such a configuration, for example, a plug docking connector 117 as shown in FIG. 26 can be used. FIG. 26 is a perspective view showing an appearance of the plug docking connector 117, FIG. 27 is a bottom plan view showing the appearance of the plug docking connector 117, FIG. 28 is an exploded view showing a configuration of the plug docking connector 117, and FIG. 29 is a sectional view taken along E-E in FIG. 27.

As shown in FIG. 28 and FIG. 29, plug connectors 118a and 118b configuring the plug docking connector 117 are not mounted on the circuit board, and a plurality of contacts 119a and 119b of the plug connectors 118a and 118b and the cables 120a and 120b are directly connected by soldering or the like. Even when the plug docking connector 117 is mounted on an electronic apparatus or the like and a position relative to a printed board mounted on the electronic apparatus differs, connection with the printed board can be realized with ease without changing a shape or a length of the plurality of contacts 119a and 119b of the plug connectors 118a and 118b. Specifically, since the contacts 119a and 119b are connected with the cables 120a and 120b, connection of the cables 120a and 120b with the printed board of the electronic apparatus enables electrical connection of the plug connectors 118a and 118b with the printed board via the cables 120a and 120b.

Additionally, although in the above plug docking connector 75 according to the second embodiment, the control portion 89a controls a position and a posture of the plug connector 76a, and the control portion 89b controls a position and a posture of the plug connector 76b, the plug docking connector can be configured to include only the control portion 89a, or only the control portion 89b. When only the control portion 89a (or 89b) is provided, a position and a posture of the plug connector 76b (or 76a) are defined in advance, and only a position and a posture of the plug connector 76a (or 76b) are controlled.

Additionally, although in the above plug docking connector 75 according to the second embodiment, the control portions 89a and 89b control the postures of the plug connectors 76a and 76b by using the Y side elastic portion 94a and the convex portions 67a and 67b of the rear cover 81, a posture control portion having an elastic portion and a convex portion can be provided between the circuit boards 82a and 82b and the rear cover 81, so that the posture control portion controls the postures of the plug connectors 76a and 76b.

Additionally, although in the above receptacle docking connector 73 according to the second embodiment, as shown in FIG. 24, the other end portions of the contacts 107a and 107b are electrically connected with the wires 109a and 109b, in place of such a configuration, a second engagement portion can be provided which engages with a connector mounted on the board 106 in advance other than a first engagement portion in which the additional receptacle connectors 103a and 103b engage with the additional plug connectors 77a and 77b. In this case, one end portions of the contacts 107a and 107b electrically connect with the contacts 116a and 116b and contacts not shown of the additional plug connectors 77a and 77b, and the other end portions of the contacts 107a and 107b electrically connect with contacts of the connector mounted on the board 106 in advance.

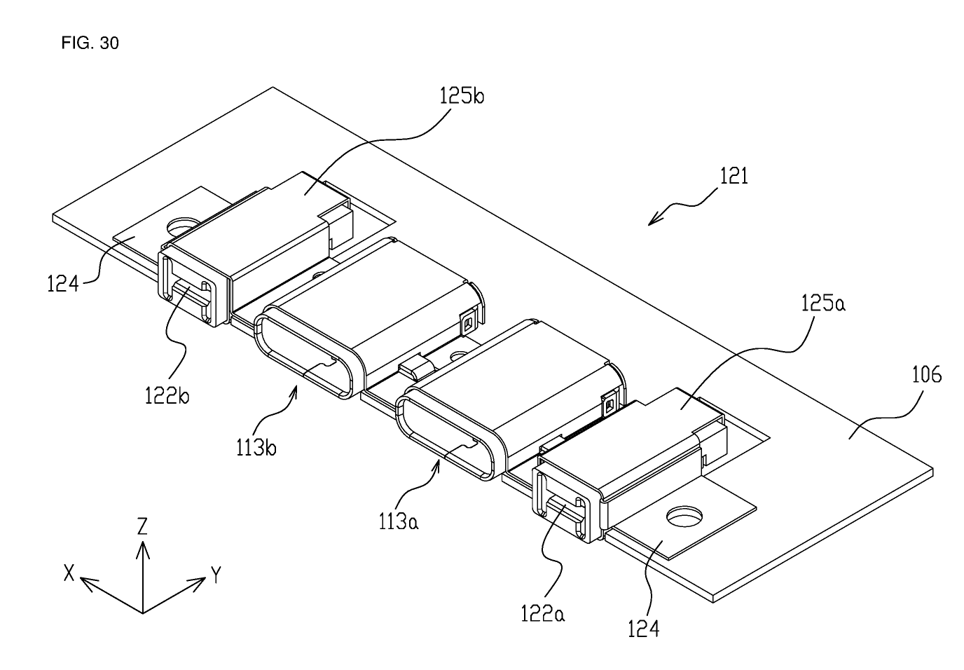

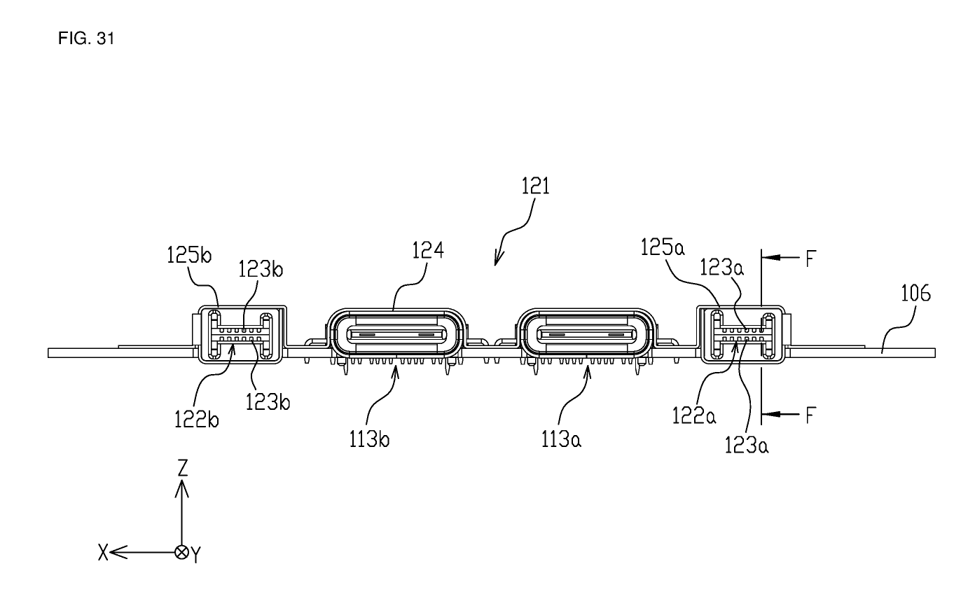

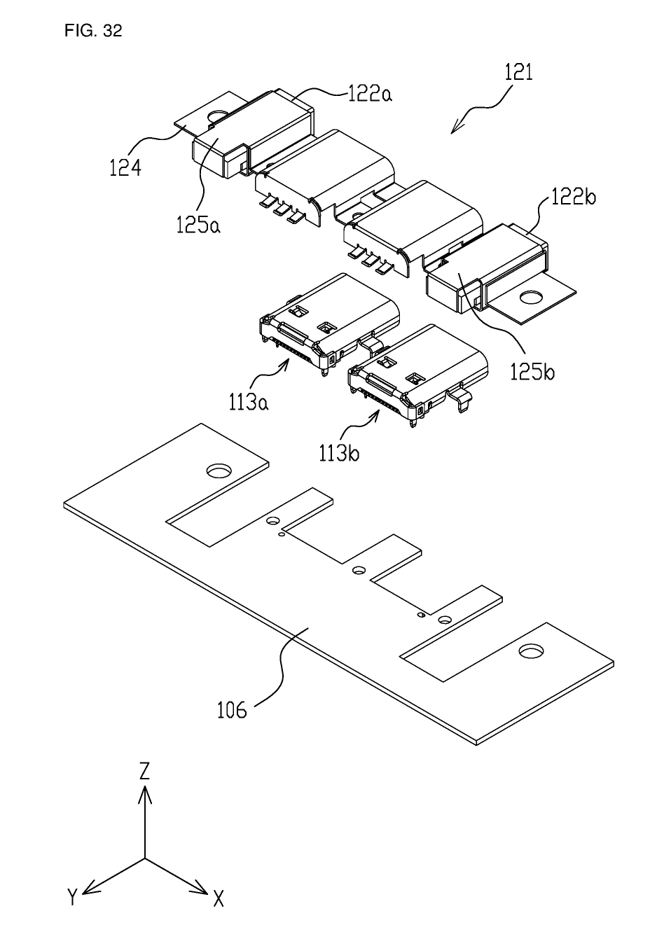

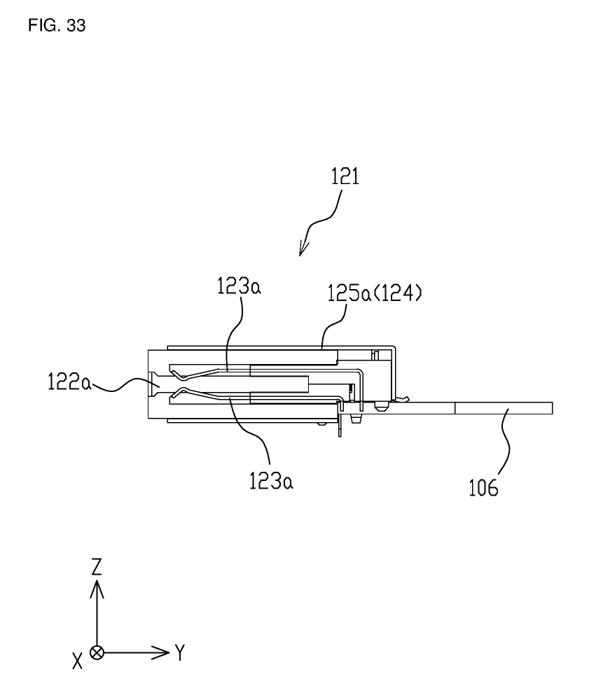

Additionally, although in the above receptacle docking connector 73 according to the second embodiment, as shown in FIG. 24, the other end portions of the contacts 107a and 107b are electrically connected with the wires 109a and 109b, in place of such a configuration, for example, a receptacle docking connector 121 can be used as shown in FIG. 30. FIG. 30 is a perspective view showing an appearance of the receptacle docking connector 121, FIG. 31 is a front view showing the appearance of the receptacle docking connector 121, FIG. 32 is an exploded view showing a configuration of the receptacle docking connector 121, and FIG. 33 is a sectional view taken along F-F in FIG. 31. As shown in FIG. 30 to FIG. 33, to contacts 123a and 123b of additional receptacle connectors 122a and 122b configuring the receptacle docking connector 121, no wire is connected. Additionally, a guide shell 124 configuring the receptacle docking connector 121 supports the additional receptacle connectors 122a and 122b in the insertion direction (the +Y direction) in which the guide portions of the plug docking connector are inserted into guide reception portions 125a and 125b.

Additionally, although the above receptacle docking connector 73 according to the second embodiment includes the two guide reception portions 102a and 102b, one guide reception portion, or three or more guide reception portions may be provided. Even when three or more guide reception portions are provided, the guide reception portions are formed integrally.

Additionally, although the receptacle docking connector 73 according to the second embodiment, which is a reversible connector, includes the two additional receptacle connectors 103a and 103b, one additional receptacle connector may be provided. In this case, when the plug connector 76a engages with the receptacle connector 113a, the additional plug connector 77a engages with the additional receptacle connector, and when the plug connector 76b engages with the receptacle connector 113b, the additional plug connector 77b engages with the additional receptacle connector.

Additionally, although in the above second embodiment, only the front end portions of the guide portions 78a and 78b protrude more than the front end portions of the plug connectors 76a and 76b, only front end portions of the guide reception portions 102a and 102b may protrude more than front end portions of the receptacle connectors 113a and 113b. Additionally, the front end portions of the guide portions 78a and 78b may protrude more than the front end portions of the plug connectors 76a and 76b, and the front end portions of the guide reception portions 102a and 102b may protrude more than the front end portions of the receptacle connectors 113a and 113b.

Additionally, although the above plug docking connectors according to second embodiment are each provided with two additional plug connectors, the plug docking connector may be provided with one or three or more additional plug connectors. Similarly, although the above receptacle docking connectors according to second embodiment are each provided with two additional receptacle connectors, the receptacle docking connector may be provided with one or three or more additional receptacle connectors.

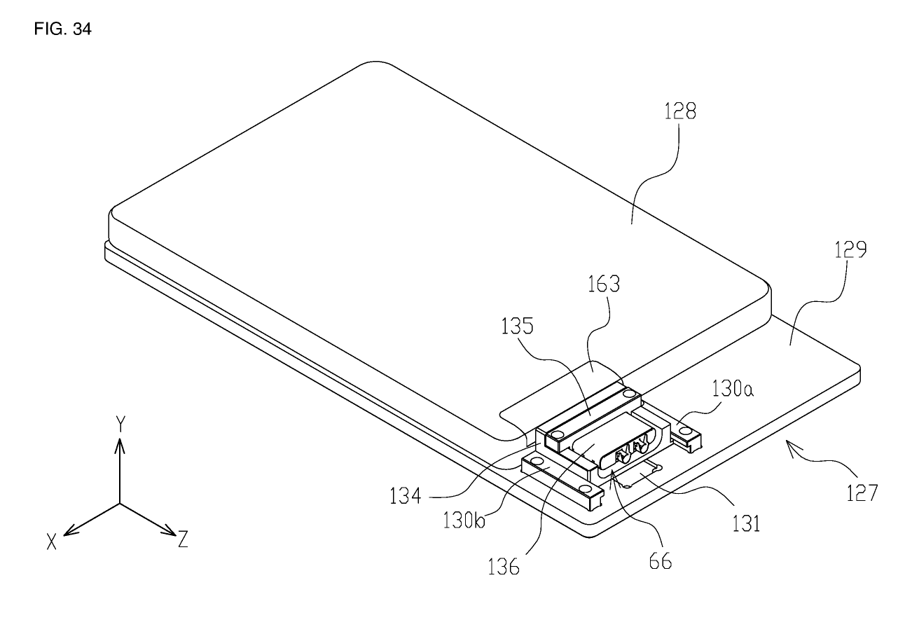

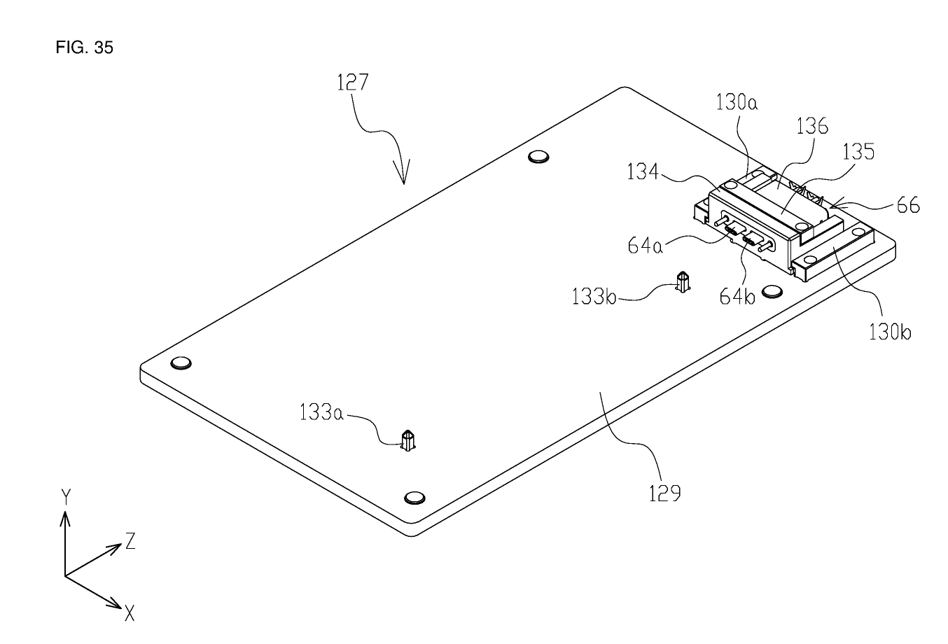

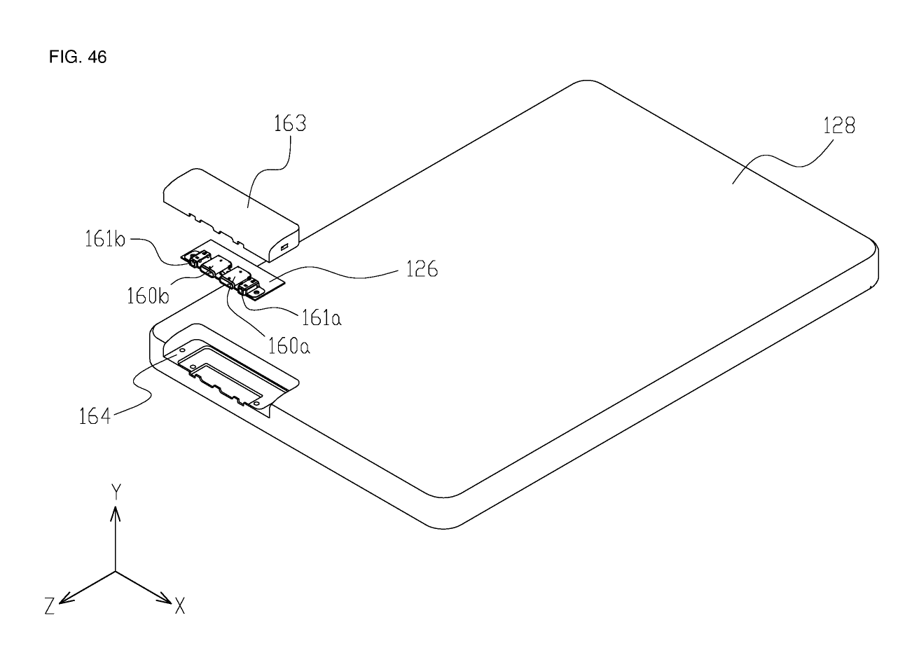

Next, description will be made of a docking connector according to a third embodiment of the present invention with reference to the drawings. FIG. 34 is a perspective view showing a state where a docking station 127 mounted with a plug unit 66 and a personal computer 128 mounted with a receptacle unit 126 (see FIG. 46) are docked according to the third embodiment, and FIG. 35 is a perspective view showing an appearance of the docking station 127 mounted with the plug unit 66. In the following, with XYZ orthogonal coordinate systems set as shown in FIG. 34 and FIG. 35, description will be made of a positional relationship and the like of each member with reference to the orthogonal coordinate systems. An X axis is set to be parallel to a direction in which two USB Type-C plug connectors 64a and 64b (see FIG. 35) are arranged. A Z axis is set to be parallel to a direction in which the plug unit 66 and the receptacle unit 126 (see FIG. 46) are engaged with each other. A Y axis is set to be in a direction orthogonal to a ZX plane.

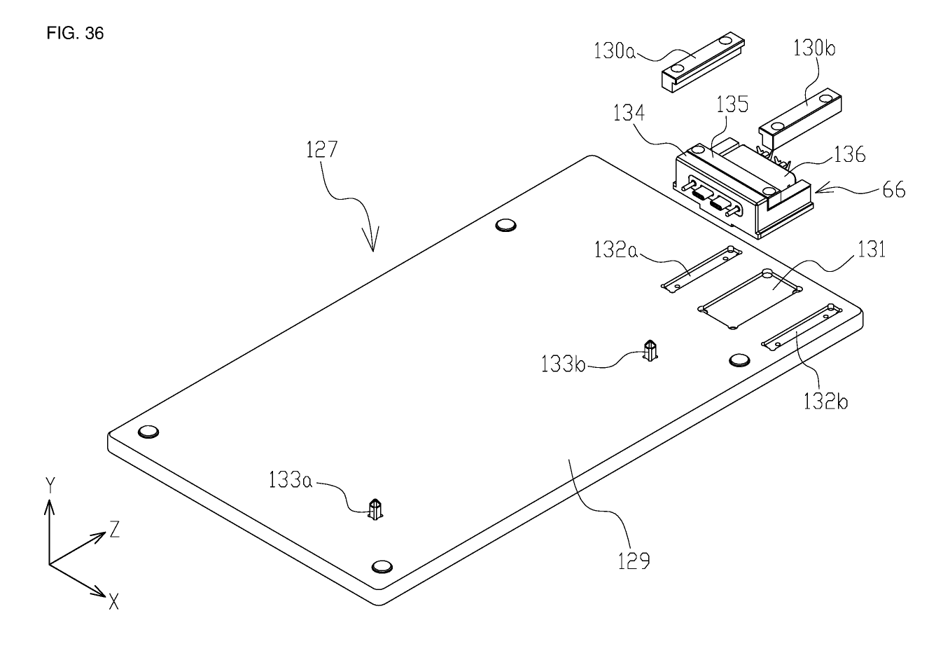

As shown in FIG. 35, the docking station 127 includes a base 129 and two guide rails 130a and 130b and is mounted with the plug unit 66. FIG. 36 is an exploded view showing a configuration of the docking station 127. As shown in FIG. 36, on the base 129, there are provided a plug unit reception portion 131 which receives the plug unit 66, and guide rail reception portions 132a and 132b which receive the two guide rails 130a and 130b. The guide rail 130a is screwed to the base 129 in a state of being received by the guide rail reception portion 132a. Similarly, the guide rail 130b is screwed to the base 129 in a state of being received by the guide rail reception portion 132b. The plug unit 66 is fit in the guide rails 130a and 130b in a state of being received by the plug unit reception portion 131 so as to be slidable in a ±Z direction. Additionally, on the base 129, two pins 133a and 133b are provided. Insertion of the pins 133a and 133b, respectively, into two holes (not shown) formed on a rear surface of the personal computer 128 leads to positioning between the personal computer 128 and the docking station 127.

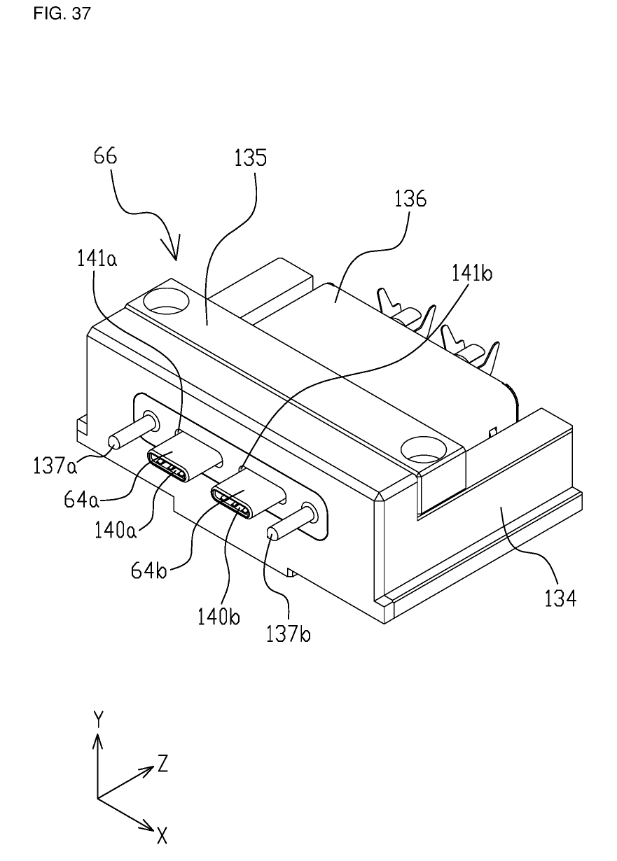

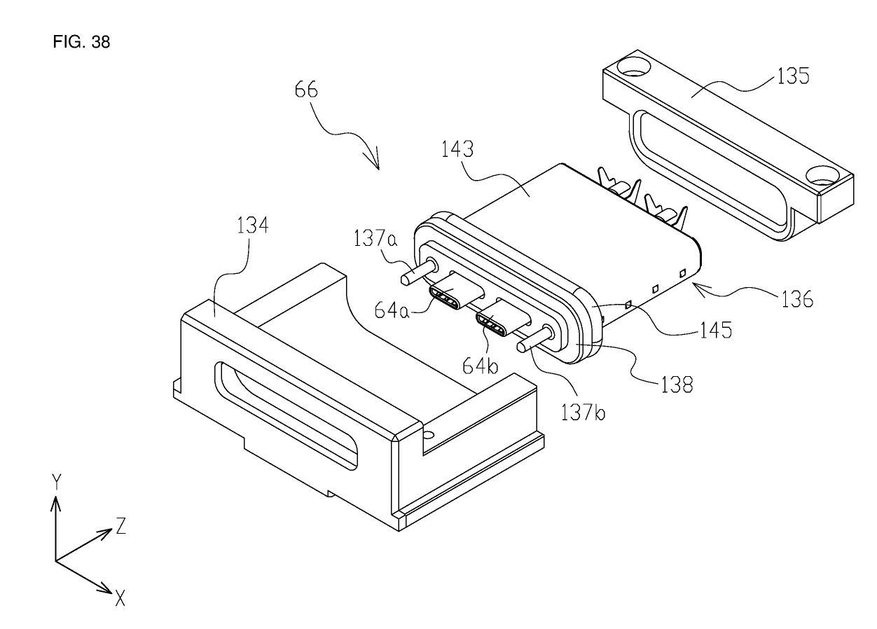

FIG. 37 is a perspective view showing an appearance of the plug unit 66, and FIG. 38 is an exploded view showing a configuration of the plug unit 66. As shown in FIG. 37 and FIG. 38, the plug unit 66 includes a docking slider 134, a bracket 135, and a plug docking connector 136. The plug docking connector 136 and the bracket 135 are installed in the docking slider 134, and the bracket 135 is screwed to the docking slider 134. Sliding of the docking slider 134 in the ±Z direction causes also the plug docking connector 136 and the bracket 135 to slide in the ±Z direction. In other words, the plug unit 66 slides in the ±Z direction.

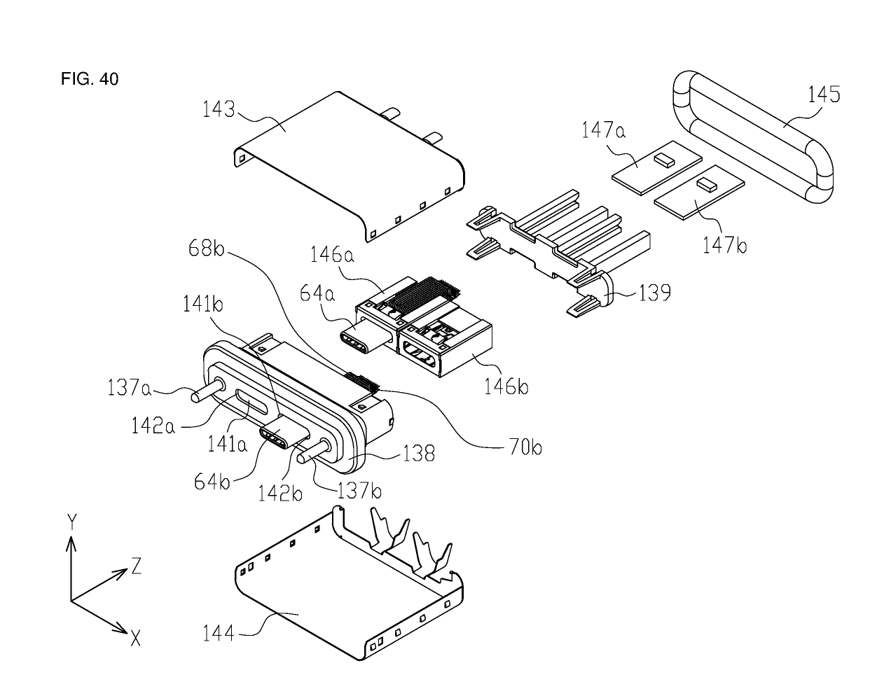

Additionally, as shown in FIG. 38, the plug docking connector 136 includes a front cover 138 having the two USB Type-C plug connectors (hereinafter, simply referred to as plug connectors) 64a and 64b, and two guide portions 137a and 137b, an upper shell 143, a lower shell 144 (see FIG. 40), and a cushion rubber 145.

The front cover 138 includes the two guide portions 137a and 137b. The two guide portions 137a and 137b are inserted into guide reception portions 161a and 161b of the receptacle unit 126 (see FIG. 46), respectively, before the plug connectors 64a and 64b engage with two USB Type-C receptacle connectors (hereinafter, simply referred to as receptacle connectors) 160a and 160b (see FIG. 46) when the personal computer 128 and the docking station 127 are docked with each other. The guide portion 137a is formed on a −X direction side of the plug connector 64a, and the guide portion 137b is formed on a +X direction side of the plug connector 64b. The front cover 138 functions as a cover which covers the plug connectors 64a and 64b.

Additionally, front end portions on a −Z direction side of the guide portions 137a and 137b protrude in the −Z direction more than front end portions on the −Z direction side of the plug connectors 64a and 64b. Specifically, the guide portions 137a and 137b protrude to an insertion direction (the −Z direction) side on which the guide portions 137a and 137b are inserted into the guide reception portions 161a and 161b of the receptacle unit 126 more than the plug connectors 64a and 64b. Accordingly, the guide portions 137a and 137b are inserted into the guide reception portions 161a and 161b of the receptacle unit 126 (see FIG. 46) before the plug connectors 64a and 64b engage with the receptacle connectors 160a and 160b (see FIG. 46) when the personal computer 128 and the docking station 127 are docked with each other.

Additionally, on the −X direction side between the guide portion 137a and the guide portion 137b of the front cover 138, there is formed an opening portion 141a covering the plug connector 64a and allowing an engagement portion 140a to be exposed, by which engagement portion the plug connector 64a engages with the receptacle connector 160a (see FIG. 46). Additionally, on the +X direction side between the guide portion 137a and the guide portion 137b of the front cover 138, there is formed an opening portion 141b covering the plug connector 64b and allowing an engagement portion 140b to be exposed, by which engagement portion, the plug connector 64b engages with the receptacle connector 160b (see FIG. 46).

Additionally, between an outer wall portion of the plug connector 64a and a wall portion 142a formed on the −Z direction side of the opening portion 141a, a predetermined space is formed such that on a surface (an XY plane) on which the opening portion 141a is formed, the plug connector 64a can move relative to the front cover 138. Similarly, between an outer wall portion of the plug connector 64b and a wall portion 142b formed on the −Z direction side of an opening portion 86b, a predetermined space is formed such that on a surface (the XY plane) in which the opening portion 141b is formed, the plug connector 64b can move relative to the front cover 138.

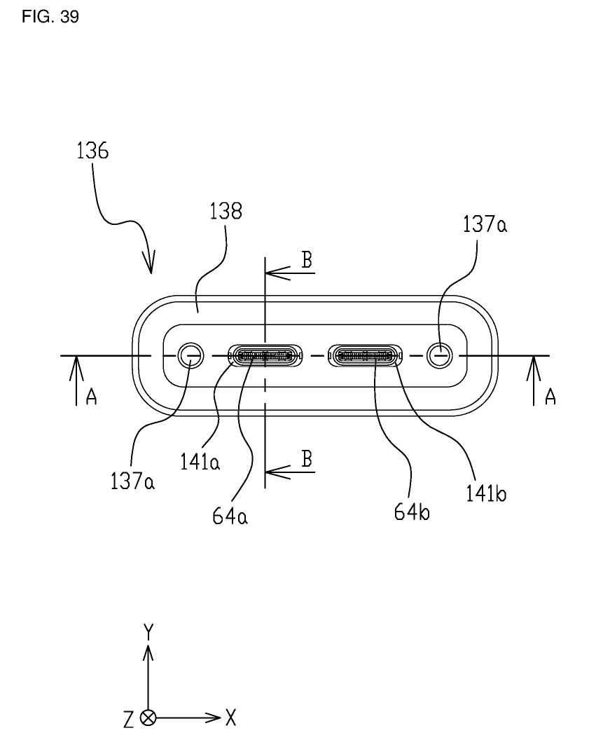

The upper shell 143 and the lower shell 144 (see FIG. 39) cover a +Z direction side of the front cover 138, floating portions 146a and 146b to be described later, a rear cover 139, and boards 147a and 147b (see FIG. 40). The cushion rubber 145 is disposed on the +Z direction side of the front cover 138. The cushion rubber 145 absorbs a deviation in position between the guide portions 137a and 137b and the guide reception portions 161a and 161b of the receptacle unit 126 (see FIG. 46) when the personal computer 128 and the docking station 127 are docked with each other.

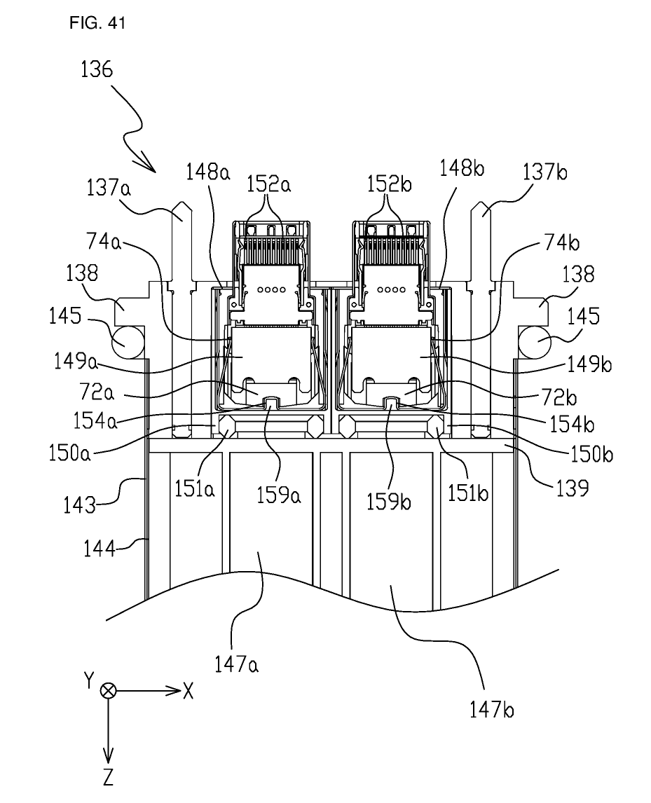

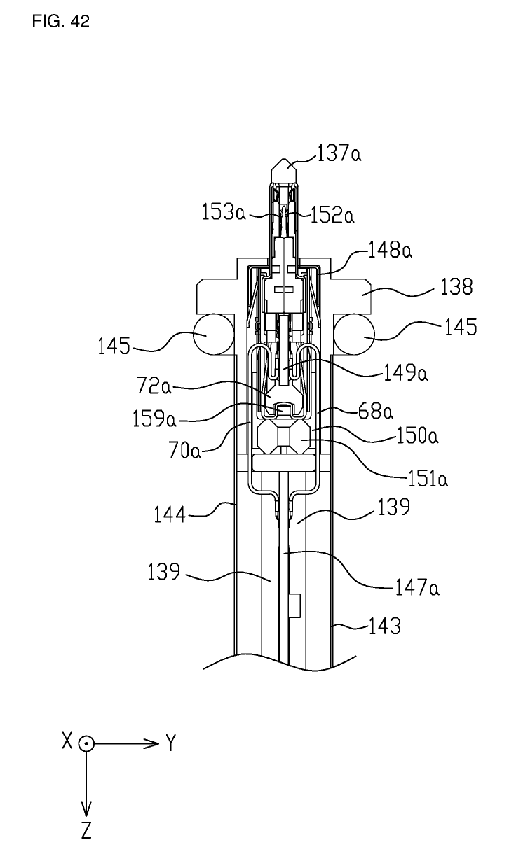

FIG. 39 is a front view showing a configuration of the plug docking connector 136, FIG. 40 is an exploded view showing the configuration of the plug docking connector 136, FIG. 41 is a sectional view taken along A-A of FIG. 39, and FIG. 42 is a sectional view taken along B-B of FIG. 39. As shown in FIG. 39 to FIG. 42, the plug docking connector 136 includes the floating portions 146a and 146b, the rear cover 139, and the boards 147a and 147b. The rear cover 139 is hooked to the front cover 138 after the floating portions 146a and 146b are inserted into the front cover 138. The boards 147a and 147b are installed in the rear cover 139. The rear cover 139 functions as a cover which covers the plug connectors 64a and 64b, together with the front cover 138.

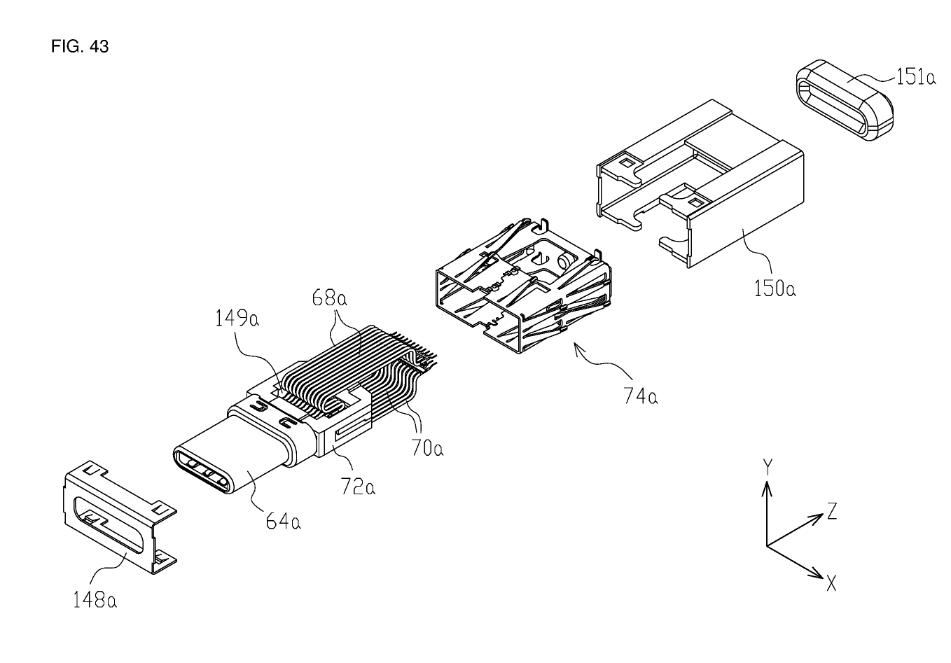

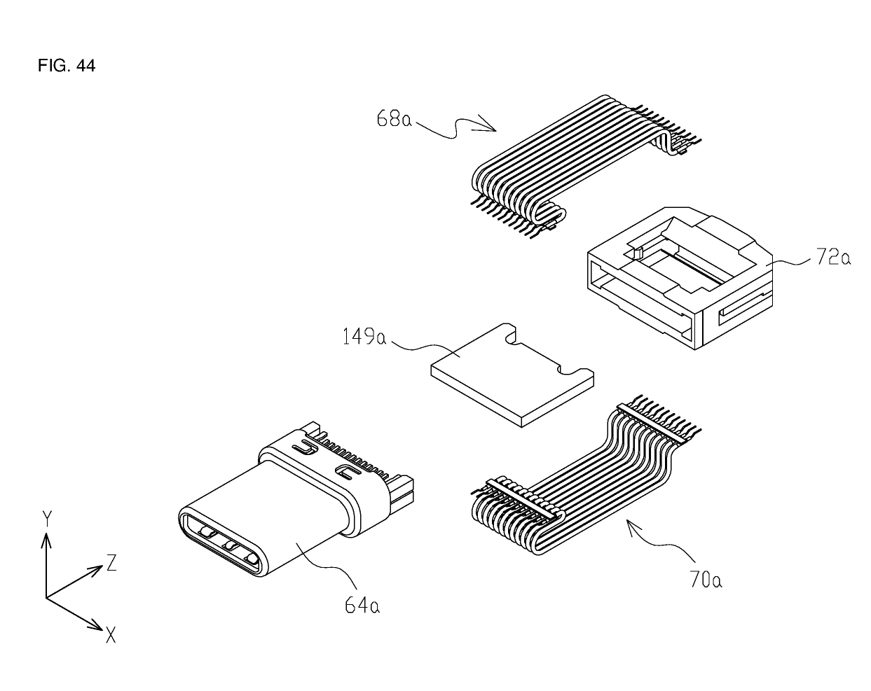

FIG. 43 is an exploded view showing a configuration of the floating portion 146a. As shown in FIG. 43, the floating portion 146a includes a stopper 148a, the plug connector 64a, a circuit board 149a, a plurality (12 in this embodiment) of upper coaxial cables 68a, a plurality (12 in this embodiment) of lower coaxial cables 70a, a swing adaptor 72a, a control portion 74a, a slider 150a, and a cushion rubber 151a. FIG. 44 is an exploded view showing configurations of the plug connector 64a, the circuit board 149a, the upper coaxial cable 68a, the lower coaxial cable 70a, and the swing adaptor 72a.

The plug connector 64a is packaged on the circuit board 149a. The plug connector 64a includes a plurality (12 in this embodiment) of upper contacts 152a and a plurality (12 in this embodiment) of lower contacts 153a which connect with a plurality of contacts (not shown) of the receptacle connector 160a (see FIG. 46) as shown in FIG. 41 and FIG. 42. Each of the plurality of upper contacts 152a is arranged on a +Y direction side of the plug connector 64a, and an end portion of the upper contact 152a on the +Z direction side is fixed to the circuit board 149a by soldering or the like. Additionally, each of the plurality of upper contacts 152a includes a contact portion at an end portion thereof on the −Z direction side, the contact portion for coming into contact with the contact of the receptacle connector 160a. Each of the plurality of lower contacts 153a is arranged on a −Y direction side of the plug connector 64a, and an end portion of the lower contact 153a on the +Z direction side is fixed to the circuit board 149a by soldering or the like. Additionally, each of the plurality of lower contacts 153a includes a contact portion at an end portion thereof on the −Z direction side, the contact portion for coming into contact with the contact of the receptacle connector 160a.

Additionally, on a surface on the +Y direction side of the circuit board 149a, one end of each of the plurality of upper coaxial cables 68a is fixed by soldering or the like. Each of the plurality of cables 68a is electrically connected with each of the plurality of upper contacts 152a arranged on the −Z direction side of the plug connector 64a via the circuit board 149a. Additionally, on a surface on the −Y direction side of the circuit board 149a, one end of each of the plurality of lower coaxial cables 70a is fixed by soldering or the like. Each of the plurality of lower coaxial cables 70a is electrically connected with each of the plurality of lower contacts 153a arranged on the −Z direction side of the plug connector 64a via the circuit board 149a. Additionally, on a surface on the +Y direction side of the board 147a, the other end of each of the plurality of upper coaxial cables 68a is fixed by soldering or the like. Additionally, on a surface on the −Y direction side of the board 147a, the other end of each of the plurality of lower coaxial cables 70a is fixed by soldering or the like.

Here, since the circuit board 149a is fixed to the plug connector 64a, and to the circuit board 149a, one end of each of the plurality of upper coaxial cables 68a and each of the plurality of lower coaxial cables 70a is fixed, the circuit board 149a functions as a first holding portion which holds one end of each of the plurality of upper coaxial cables 68a and each of the plurality of lower coaxial cables 70a. Additionally, since the board 147a is fixed to the rear cover 139, and to the board 147a, the other end of each of the plurality of upper coaxial cables 68a and each of the plurality of lower coaxial cables 70a is fixed, the board 147a functions as a second holding portion which holds the other end of each of the plurality of upper coaxial cables 68a and each of the plurality of lower coaxial cables 70a. Additionally, the upper coaxial cable 68a and the lower coaxial cable 70a each have a flexible portion which follows movement of the plug connector 64a between the circuit board 149a as the first holding portion and the board 147a as the second holding portion.

Provision of the flexible portions, and the first holding portion and the second holding portion enables the plug connector 64a to move relative to the front cover 138 and the rear cover 139 without being restrained by other member. The flexible portions may not necessarily be the upper coaxial cable 68a and the lower coaxial cable 70a, but may be, for example, the contacts 152a and 153a of the plug connector 64a. Additionally, the first holding portion may not necessarily be the circuit board 149a, but may be, for example, the plug connector 64a.

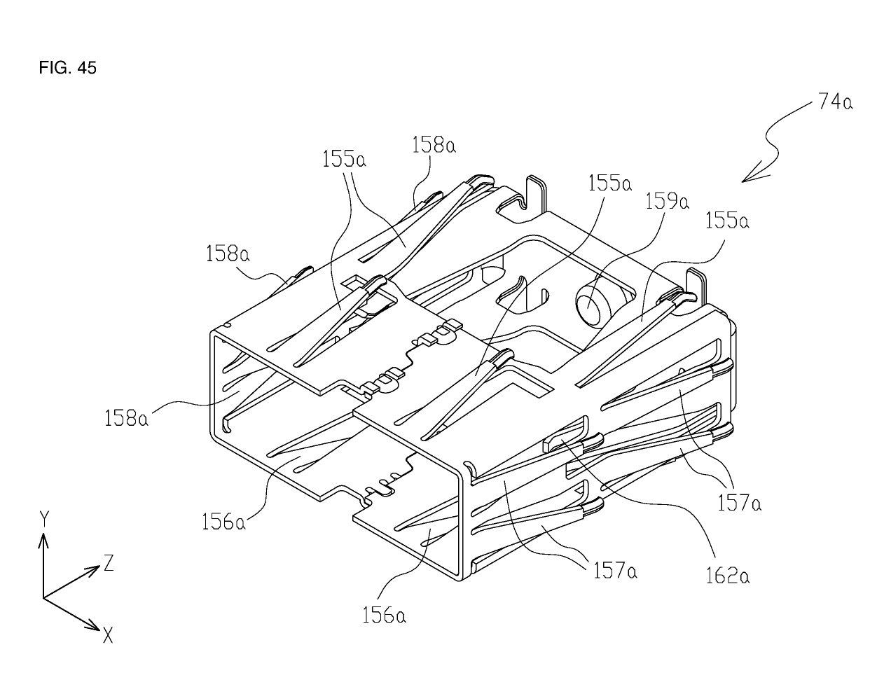

Next, configurations of the swing adaptor 72a, the control portion 74a, the slider 150a, and the cushion rubber 151a will be described. The swing adaptor 72a is arranged in the vicinity of the circuit board 149a. A surface on the +Z direction side of the swing adaptor 72a is a curved surface as shown in FIG. 41 and FIG. 43, a center portion of which has a concave portion 154a which receives a convex portion 159a of the control portion 74a (see FIG. 45). The swing adaptor 72a rotates along the curved surface, with the concave portion 154a fit in the convex portion 159a of the control portion 74a as an axis.

The control portion 74a, which is installed so as to cover the swing adaptor 72a, controls a position of the plug connector 64a in the X direction and the Y direction, and a posture of the plug connector 64a. FIG. 45 is a perspective view showing a configuration of the control portion 74a. The control portion 74a is formed of a member having conductive properties, for example, metal, and on the +Y direction side of the control portion 74a, four Y side elastic portions 155a are formed as shown in FIG. 45. Additionally, on the −Y direction side of the control portion 74a, four Y side elastic portions (two Y side elastic portions 156a and two Y side elastic portions not shown) are formed. The Y side elastic portion 155a pushes, in the +Y direction, an inner surface on the +Y direction side of the slider 150a by an elastic force. The inner surface on the +Y direction side of the slider 150a receives the elastic force of the Y side elastic portion 155a. The Y side elastic portion 156a pushes, in the −Y direction, an inner surface on the −Y direction side of the slider 150a by an elastic force. The inner surface on the −Y direction side of the slider 150a receives the elastic force of the Y side elastic portion 156a.

The control portion 74a controls a position of the plug connector 64a in the Y direction with respect to the opening portion 141a by using the elastic forces of the Y side elastic portions 155a and 156a. For example, when a force is applied to the plug connector 64a in the −Y direction, the Y side elastic portion 155a extends in the +Y direction and the Y side elastic portion 156a contracts in the +Y direction. Accordingly, the plug connector 64a moves in the −Y direction within the predetermined space formed between the outer wall portion of the plug connector 64a and the wall portion 142a. When a force is applied to the plug connector 64a in the +Y direction, the Y side elastic portion 155a contracts in the −Y direction and the Y side elastic portion 156a extends in the −Y direction. Accordingly, the plug connector 64a moves in the +Y direction within the predetermined space formed between the outer wall portion of the plug connector 64a and the wall portion 142a.

Additionally, on the +X direction side of the control portion 74a, four X side elastic portions 157a are formed as shown in FIG. 45. Additionally, on the −X direction side of the control portion 74a, four X side elastic portions (three X side elastic portions 158a and one X side elastic portion not shown) are formed. The X side elastic portion 157a pushes, in the +X direction, an inner surface on the +X direction side of the slider 150a by an elastic force. The inner surface on the +X direction side of the slider 150a receives the elastic force of the X side elastic portion 157a. The X side elastic portion 158a pushes, in the −X direction, an inner surface on the −X direction side of the slider 150a by an elastic force. The inner surface on the −X direction side of the slider 150a receives the elastic force of the X side elastic portion 158a.

The control portion 74a controls a position of the plug connector 64a in the X direction with respect to the opening portion 141a by using the elastic forces of the X side elastic portions 157a and 158a. For example, when a force is applied to the plug connector 64a in the −X direction, the X side elastic portion 157a extends in the +X direction and the X side elastic portion 158a contracts in the +X direction. Accordingly, the plug connector 64a moves in the −X direction within the predetermined space formed between the outer wall portion of the plug connector 64a and the wall portion 142a. When a force is applied to the plug connector 64a in the +X direction, the X side elastic portion 157a contracts in the −X direction and the X side elastic portion 158a extends in the −X direction. Accordingly, the plug connector 64a moves in the +X direction within the predetermined space formed between the outer wall portion of the plug connector 64a and the wall portion 142a.

Additionally, on an inner surface on the +X direction side of the control portion 74a, an inner elastic portion 162a is formed. Additionally, also on an inner surface on the −X direction side of the control portion 74a, an inner elastic portion not shown is formed. Additionally, on a surface on the +Z direction side of the control portion 74a, as shown in FIG. 45, the convex portion 159a is formed. As described above, the convex portion 159a is fit in the concave portion 154a of the swing adaptor 72a to function as an axis for the swing adaptor 72a to rotate. Using the inner elastic portion 162a, the inner elastic portion not shown, and the convex portion 159a, the swing adaptor 72a and the control portion 74a control a posture of the plug connector 64a with respect to the opening portion 141a, i.e. a slant with respect to the Z axis direction. For example, when a force slanting to the Z axis direction is applied to the plug connector 64a, the swing adaptor 72a slants with the convex portion 159a of the control portion 74a as an axis. Then, the posture of the plug connector 64a changes to a direction in which the force is applied within the predetermined space formed between the outer wall portion of the plug connector 64a and the wall portion 142a. Specifically, the plug connector 64a slants to a surface in which the opening portion 141a is formed. The inner elastic portion 162a or the inner elastic portion not shown arranged on the side to which the plug connector 64a slants functions as a correction portion which corrects a slant of the plug connector 64a by using an elastic force to push the plug connector 64a. When the force applied to the plug connector 64a is released, due to the elastic force of the inner elastic portion 162a or the inner elastic portion not shown, the plug connector 64a returns to a previous posture as of before the force is applied to the plug connector 64a.

The slider 150a is installed so as to cover the control portion 74a and the cushion rubber 151a. The slider 150a and the cushion rubber 151a function as a control portion which controls a position of the plug connector 64a in the Z direction. Specifically, as shown in FIG. 41 and FIG. 42, the slider 150a is configured to be movable in the ±Z direction, and the cushion rubber 151a absorbs the movement of the slider 150a in the Z direction. Accordingly, at the engagement between the plug connector 64a and the receptacle connector 160a (see FIG. 46), when the front end portion of the plug connector 64a comes into contact with an abutting surface of the receptacle connector 160a, the slider 150a move in the +Z direction, so that the cushion rubber 151a absorbs the movement of the slider 150a, thereby preventing the front end portion of the plug connector 64a from colliding against the abutting surface of the receptacle connector 160a. Although in general, the receptacle connector 160a is designed to have an abutting surface not coming into contact with the front end portion of the plug connector 64a, the front end portion of the plug connector 64a might collide with the abutting surface of the receptacle connector 160a at the time of engagement due to deviation in installation or packaging of each part. However, even in such a case, provision of the slider 150a and the cushion rubber 151a avoids collision of the abutting surface of the receptacle connector 160a with the front end portion of the plug connector 64a, thereby preventing the plug connector 64a or the receptacle connector 160a from coming out of the board due to collision.

Similarly to the floating portion 146a, the floating portion 146b includes a stopper 148b (see FIG. 41), the plug connector 64b (see FIG. 40), a circuit board 149b (see FIG. 41), a plurality of upper coaxial cables 68b (see FIG. 40), a plurality of lower coaxial cables 70b (see FIG. 40), a swing adaptor 72b (see FIG. 41), a control portion 74b (see FIG. 41), a slider 150b (see FIG. 41), and a cushion rubber 151b (see FIG. 41). Additionally, the plug connector 64b includes a plurality of upper contacts 152b (see FIG. 41) and a plurality of lower contacts (not shown) similarly to the plug connector 64a. Additionally, the swing adaptor 72b has, in a center portion thereof, a concave portion 154b (see FIG. 41) which receives a convex portion 159b (see FIG. 41) of the control portion 74b. Additionally, in the control portion 74b, there are formed eight Y side elastic portions (not shown), eight X side elastic portions (not shown), two inner elastic portions (not shown), and the convex portion 159b. Since configurations of these portions are the same as those of the stopper 148a, the plug connector 64a, the circuit board 149a, the plurality of upper coaxial cables 68a, the plurality of lower coaxial cables 70a, the swing adaptor 72a, the control portion 74a, the slider 150a, and the cushion rubber 151a, no description will be made thereof.

Next, description will be made of the receptacle unit 126 (see FIG. 46) to be mounted on the personal computer 128 shown in FIG. 34. FIG. 46 is an exploded view showing a configuration of the personal computer 128. As shown in FIG. 46, the personal computer 128 includes the receptacle unit 126 to be engaged with the plug unit 66 for electrical connection. On the +Z direction side of the personal computer 128, a reception portion 164 which receives the receptacle unit 126 is formed, and the receptacle unit 126 is accorumodated in the reception portion 164 and covered by a cover 163. The receptacle unit 126 includes the receptacle connector 160a which engages with the plug connector 64a, the receptacle connector 160b which engages with the plug connector 64b, the guide reception portion 161a which receives the guide portion 137a, and the guide reception portion 161b which receives the guide portion 137b. Since a configuration of the receptacle unit 126 is generally the same as the configuration of the receptacle docking connector 73 according to the second embodiment (see FIG. 18), no description will be made thereof.

Since the plug unit 66 according to the third embodiment includes the guide portions 137a and 137b, before the plug connectors 64a and 64b engage with the receptacle connectors 160a and 160b, the guide portions 137a and 137b are inserted into the guide reception portions 161a and 161b of the receptacle unit 126. Accordingly, the plug connectors 64a and 64b can be securely engaged with the receptacle connectors 160a and 160b without damages.

Additionally, the plug unit 66 according to the third embodiment includes the control portions 74a and 74b, the swing adaptors 72a and 72b, the sliders 150a and 150b, and the cushion rubbers 151a and 151b. Additionally, the plug connectors 64a and 64b are connected with the upper coaxial cables 68a and 68b and the lower coaxial cables 70a and 70b (the flexible portions) via the circuit boards 149a and 149b, which flexible portions are held by the first holding portion and the second holding portion. Accordingly, position control and posture control of the plug connectors 64a and 64b can be excellently conducted. In other words, since the plug connectors 64a and 64b are configured to be movable within a predetermined space, a tolerance can be minimized to enable the plug connectors 64a and 64b to be securely engaged with the receptacle connectors 160a and 160b without damages. Additionally, without engagement with the receptacle connectors 160a and 160b, position control and posture control by the control portions 74a and 74b and the cushion rubbers 151a and 151b enable the plug connectors 64a and 64b to be maintained at a predetermined position and in a predetermined posture. In other words, deviation in a position and a posture of the plug connectors 64a and 64b during mounting thereof can be securely absorbed.

Additionally, since the receptacle unit 126 according to the third embodiment includes the guide reception portions 161a and 161b, the guide portions 137a and 137b are inserted into the guide reception portions 161a and 161b before the plug connectors 64a and 64b engage with the receptacle connectors 160a and 160b. Accordingly, the plug connectors 64a and 64b can be securely engaged with the receptacle connectors 160a and 160b without damages.

Although in the above-described plug unit 66 according to the third embodiment, the control portion 74a and the like control a position and a posture of the plug connector 64a, and the control portion 74b and the like control a position and a posture of the plug connector 64b, only the control portion 74a and the like may be provided, or only the control portion 74b and the like may be provided. In a case where only the control portion 74a and the like (or 74b and the like) are provided, a position and a posture of the plug connector 64b (or 64a) are defined in advance to control a position and a posture of the plug connector 64a (or 64b).

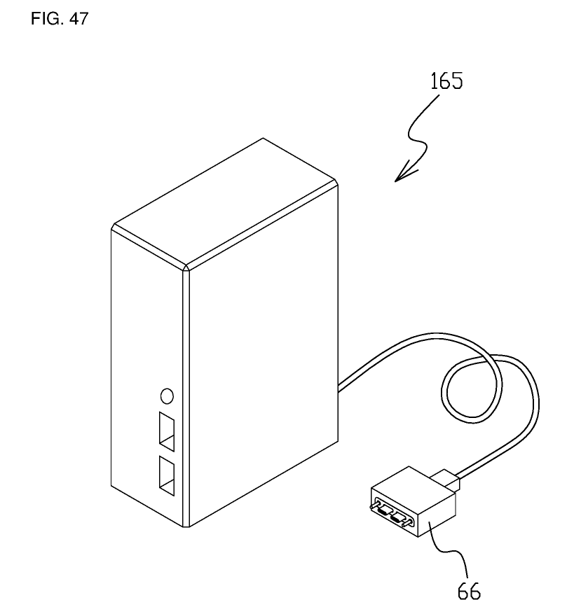

Additionally, the above-described plug unit 66 according to the third embodiment, which is mounted on the docking station 127, may be mounted on, for example, such a cable dock 165 as shown in FIG. 47.

Although the above plug docking connectors according to the respective embodiments are each provided with two USB Type-C plug connectors, the plug docking connector may be provided with three or more USB Type-C plug connectors. Additionally, a USB Type-C plug connector may be replaced by other plurality of plug connectors conforming to the standard specification than a USB Type-C plug connector. Additionally, a plurality of predetermined standard plug connectors having a predetermined standard may be provided other than the plug connectors conforming to the standard specification.

Similarly, although the above receptacle docking connectors according to second embodiment are each provided with two USB Type-C receptacle connectors, the receptacle docking connector may be provided with three or more USB Type-C receptacle connectors. Additionally, a USB Type-C receptacle connector may be replaced by other plurality of receptacle connectors conforming to the standard specification than a USB Type-C receptacle connector. Additionally, a plurality of predetermined standard receptacle connectors having a predetermined standard may be provided other than the receptacle connectors conforming to the standard specification.

Additionally, although the above respective embodiments are configured such that a position and a posture of the plug connector are controlled, the embodiments may be configured such that only a position of the plug connector is controlled, or such that only a posture of the plug connector is controlled.

Additionally, although in the above-described second and third embodiments, the guide portion and the guide reception portion are provided, neither guide portion nor guide reception portion may be provided.

The above embodiments have been described for illustrative purpose only and are not to be construed as limiting the present invention. Accordingly, each element disclosed in the above embodiments intends to include all design changes and equivalents within a technical range of the present invention.

1. A connector comprising:
a plurality of predetermined standard connectors which connects with a partner connector; and
a cover covering the plurality of predetermined standard connectors and having a first opening portion allowing an engagement portion to be exposed, the engagement portion to be engaged with the partner connector of the predetermined standard connector, wherein
between an outer wall portion of the predetermined standard connector and a wall portion forming the first opening portion, a predetermined space is formed such that the predetermined standard connector is movable relative to the cover on a cross plane crossing an engagement direction of engagement with the partner connector, the connector comprising:
a first control portion which controls, with respect to the first opening portion, at least either one of a position and a posture of at least one of the predetermined standard connectors.

2. The connector according to claim 1, further comprising:
an additional connector to be connected with a partner's additional connector, wherein
the cover covers the additional connector and has a second opening portion allowing an engagement portion of the additional connector to be exposed, the engagement portion to be engaged with the partner's additional connector, and
between an outer wall portion of the additional connector and a wall portion forming the second opening portion, a predetermined space is formed such that the additional connector is movable on the cross plane, the connector comprising:
a second control portion which controls, with respect to the second opening portion, at least either one of a position and a posture of the additional connector.

3. The connector according to claim 2, wherein the first control portion and the second control portion each include an elastic body.

4. The connector according to claim 1, wherein the first control portion is provided in the outer wall portion of the predetermined standard connector or in the wall portion forming the first opening portion.

5. The connector according to claim 2, wherein the second control portion is provided in the outer wall portion of the additional connector or in the wall portion forming the second opening portion.

6. The connector according to claim 1, wherein the first control portion is provided between the predetermined standard connector and the cover.

7. The connector according to claim 1, wherein the first control portion comprises:
a convex portion which supports the predetermined standard connector in a direction orthogonal to a surface in which the first opening portion is formed; and
a correction portion which corrects a slant of the predetermined standard connector when the predetermined standard connector slants with respect to the surface in which the first opening portion is formed, and
controls a posture of the predetermined standard connector with respect to the first opening portion by using the convex portion and the correction portion.

8. The connector according to claim 1, wherein the cover and a shell of the predetermined standard connector electrically conduct with each other.

9. The connector according to claim 1, further comprising:
a flexible portion which follows movement of the predetermined standard connector;
a first holding portion fixed to the predetermined standard connector and holding one of the flexible portion; and
a second holding portion fixed to the cover and holding the other of the flexible portion.

10. The connector according to claim 1, wherein the predetermined standard connector comprises:
a first contact having a first connection portion which is pushed to a first conductor to electrically connect with the first conductor;
a first supporting portion which receives a force to push the first connection portion to the first conductor;
a second contact having a second connection portion which is pushed to a second conductor to electrically connect with the second conductor;
a second supporting portion which receives a force to push the second connection portion to the second conductor;
a ground plate arranged between the first contact and the second contact and having a shield connection portion which is pushed to at least one of a first shield portion covering the first conductor and a second shield portion covering the second conductor to electrically connect with at least one of the first shield portion and the second shield portion; and
a third supporting portion which receives a force to push the shield connection portion to at least one of the first shield portion and the second shield portion.

11. A connector comprising:
a first contact having a first connection portion which is pushed to a first conductor to electrically connect with the first conductor;
a first supporting portion which receives a force to push the first connection portion to the first conductor;
a second contact having a second connection portion which is pushed to a second conductor to electrically connect with the second conductor;
a second supporting portion which receives a force to push the second connection portion to the second conductor;
a ground plate arranged between the first contact and the second contact and having a shield connection portion which is pushed to at least one of a first shield portion covering the first conductor and a second shield portion covering the second conductor to electrically connect with at least one of the first shield portion and the second shield portion; and
a third supporting portion which receives a force to push the shield connection portion to at least one of the first shield portion and the second shield portion.

12. The connector according to claim 11, wherein at least one of the first connection portion and the second connection portion is integrally formed with the third supporting portion.

13. The connector according to claim 11, wherein the first conductor and the second conductor are each a conductor configuring a flexible flat cable or a conductor foil configuring a flexible printed board.

14. The connector according to claim 1, wherein the predetermined standard connector is of the USB Type C.
